(19) United States
(12) Patent Application Publication
(10) Pub. No.: US 2026/0252165 A1
(43) Pub. Date: Aug. 27, 2026

(54) INFORMATION PROCESSING APPARATUS, INFORMATION PROCESSING SYSTEM, STORAGE MEDIUM, AND INFORMATION PROCESSING METHOD

(71) Applicant: CANON KABUSHIKI KAISHA, Tokyo (JP)

(72) Inventor: YUMA KITASEI, Kanagawa (JP)

(21) Appl. No.: 19/533,012

(22) Filed: Feb. 6, 2026

(30) Foreign Application Priority Data
Feb. 27, 2025 (JP) 2025-030296

(51) Int. Cl. G06F 3/01

(52) U.S. Cl. CPC G06F 3/011

(57) ABSTRACT

An information processing apparatus adapted to be connected to or integrated into a display device includes a processor, and a memory storing instructions that, when executed by the processor, cause the information processing apparatus to: execute acquisition processing for acquiring an operation performed on a virtual object located in a space; in a case where a first operation different from an operation for changing a location of the virtual object has been acquired by the acquisition processing, perform control to execute, on the virtual object, first processing corresponding to the first operation and different from processing for changing a location of the virtual object; and, in a case where a predetermined condition is satisfied, even if the first operation is acquired by the acquisition processing, perform control to execute second processing different from the first processing and related to a relocation of the virtual object in the space.

### BACKGROUND

### Field of the Technology

The present disclosure relates to an information processing apparatus.

### Description of the Related Art

Typical input operations which are performed by the user using a head-mounted display (HMD) include, for example, an operation obtained by combining the line of sight and hand gestures and a ray operation with a controller used therefor. Moreover, such typical input operations include, for example, Direct Touch, in which the user directly touches a computer graphics (CG) object with the hand recognized by hand tracking (finger tracking).

If an operation target such as a virtual object is small, operations which do not match the user's intentions may be performed. To address such an issue, Japanese Patent Laid-Open No. 2012-104095 describes a method which prevents erroneous operations in a case where an object targeted for operation is displayed small on a tablet terminal and performs operations which match the user's intentions by performing processing corresponding to the display size of the object.

### SUMMARY

Embodiments of the present disclosure are directed to improving user operability even with regard to an operation in a three-dimensional space.

According to an aspect of the present disclosure, an information processing apparatus adapted to be connected to or integrated into a display device includes a processor and a memory storing instructions. The instructions, when executed by the processor, cause the information processing apparatus to execute acquisition processing for acquiring an operation performed on a virtual object located in a space; in a case where a first operation different from an operation for changing a location of the virtual object has been acquired by the acquisition processing, perform control to execute, on the virtual object, first processing corresponding to the first operation and different from processing for changing a location of the virtual object; and, in a case where a predetermined condition is satisfied, even if the first operation is acquired by the acquisition processing, perform control to execute second processing different from the first processing and related to a relocation of the virtual object in the space.

Features of various embodiments will become apparent from the following description of embodiments with reference to the attached drawings. The following description of embodiments is described by way of example.

### BRIEF DESCRIPTION OF THE DRAWINGS

FIG. 1 is a diagram illustrating an internal configuration of an information processing apparatus according to a first embodiment of the present disclosure.

FIG. 2 is a diagram representing how a computer graphics (CG) object looks to the user in a case where the CG object is in an appropriate location (appropriate size, position, and orientation).

FIG. 3 is a diagram representing how a CG object looks to the user in a case where the CG object is small and is displayed at an inappropriate size.

FIG. 4 is a diagram representing how a CG object looks to the user in a case where the CG object is located at a position higher than the eye level of the user.

FIG. 5 is a diagram representing how a CG object looks to the user in a case where, in front of the CG object, another CG object is located as an obstacle.

FIG. 6 is a diagram representing how a CG object looks to the user in a case where the CG object is located obliquely in the yaw direction relative to the user.

FIG. 7 is a diagram representing a space obtained when the space illustrated in FIG. 2 is viewed from a higher perspective.

FIG. 8 is a diagram representing a space obtained when the space illustrated in FIG. 6 is viewed from a higher perspective.

FIG. 9 is a diagram representing how a CG object looks to the user in a case where the CG object is located obliquely in the pitch direction relative to the user.

FIG. 10 is a diagram illustrating a CG object equipped with user interface (UI) parts serving as a browser.

FIG. 11 is a flowchart illustrating processing for determining whether to perform relocation of a CG object or to execute processing corresponding to an input operation in the first embodiment.

FIG. 12 is a flowchart illustrating processing for determining whether to perform relocation of a CG object or to execute processing corresponding to an input operation in the first embodiment.

FIG. 13 is a flowchart illustrating processing for performing relocation of a CG object in a second embodiment.

FIG. 14 is a flowchart illustrating processing for determining whether to perform relocation of a CG object or to execute processing corresponding to an input operation in a third embodiment.

FIG. 15 is a flowchart illustrating processing for performing relocation of a CG object in the third embodiment.

FIG. 16 is a flowchart illustrating processing for determining whether to perform relocation of a CG object or to execute processing corresponding to an input operation in a fourth embodiment.

FIG. 17 is a flowchart illustrating processing for determining whether to bring a CG object back into a location state obtained before the relocation thereof in a fifth embodiment.

FIG. 18 is a diagram representing a scene in which two users are concurrently watching a shared CG object.

FIG. 19 is a diagram representing a scene in which a user is watching a relocated CG object.

FIG. 20 is a diagram representing a scene in which a user is watching an un-relocated CG object.

FIG. 21 is a diagram representing a scene in which a user is watching a relocated CG object.

FIG. 22 is a diagram representing a scene in which a user has changed the location of a CG object.

FIG. 23 is a diagram representing a scene in which a user is watching a CG object the location of which has been changed.

FIG. 24 is a diagram representing a scene in which the location of a CG object is changed at the end of an input operation.

FIG. 25 is a diagram representing a scene in which two users are concurrently watching a shared CG object after the end of an input operation.

FIG. 26 is a flowchart illustrating the entire processing in a sixth embodiment.

FIG. 27 is a diagram illustrating a CG object equipped with UI parts serving as a browser.

FIG. 28 is a diagram illustrating a CG object to which an effect has been applied in whole.

FIG. 29 is a diagram illustrating a CG object to which an effect has been applied in part.

### DESCRIPTION OF THE EMBODIMENTS

Various embodiments, features, and aspects of the present disclosure will be described in detail below with reference to the drawings. Identical or equivalent constituent elements, members, and processing operations illustrated in the drawings are assumed to be assigned the respective same reference characters, and any duplicate descriptions thereof are omitted as appropriate. Moreover, in the drawings, some of the constituent elements, members, and processing operations are omitted from illustration. The following embodiments are not intended to limit the present disclosure, and not all of the combinations of features of described in the respective embodiments are necessarily essential for solutions of the present disclosure. The configurations of the respective embodiments can be modified or altered as appropriate depending on the specifications of apparatuses to which the present disclosure can be applied and various conditions (such as use conditions and usage environments).

The method described in Japanese Patent Laid-Open No. 2012-104095 is intended to be used for a tablet terminal, and thus does not suppose an input operation which is performed on a three-dimensional space such as a head-mounted display (HMD).

In the description of the following embodiments, identical constituent elements are assigned the respective same reference characters.

### First Embodiment

In a first embodiment, a use case in which the user wears an HMD and uses an application for a virtual window, such as a browser, is supposed. Moreover, a computer graphics (CG) object (virtual object) is described based on the assumption of a window application having a browser function which is operable by the user. The window application having a browser function is merely an example, and the CG object is not limited to a browser or a window application.

In the first embodiment, a method which, in a case where an input operation has been performed on a CG object by the user, if there is a situation in which an erroneous operation is likely to occur, relocates the CG object in such a manner that a situation in which an erroneous operation is unlikely to occur appears is described. Moreover, a method which, if there is no situation in which an erroneous operation is likely to occur, switches processing in such a way as to execute processing corresponding to the input operation, thus preventing the occurrence of an erroneous operation and performing operations which match the user's intentions, is described.

### Configuration of Information Processing Apparatus

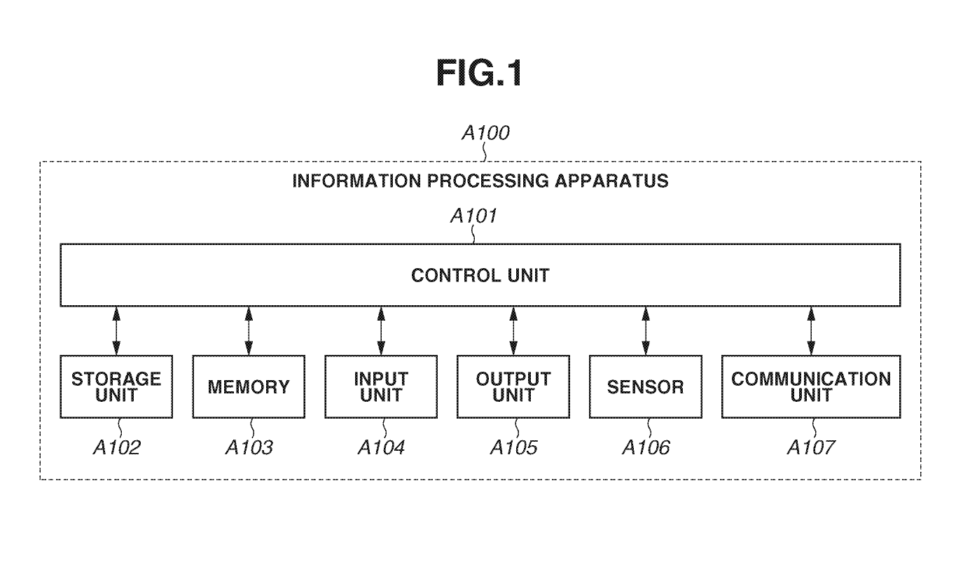

In the following description, a configuration of an information processing apparatus according to the first embodiment is described with reference to FIG. 1.

FIG. 1 is a block diagram of the information processing apparatus in the first embodiment. In the description of the first embodiment, an HMD is supposed to be the information processing apparatus A100. Furthermore, while, in the first embodiment, an HMD is supposed as an example of an apparatus constituting an information processing system, the present disclosure is not limited to such a configuration. For example, the information processing apparatus can be a smartphone or tablet terminal equipped with a camera, or the information processing apparatus can be another type of apparatus such as a personal computer (PC) or a digital camera. Moreover, while an HMD is supposed as an example of a head-mounted display device with an information processing apparatus incorporated thereinto, the information processing apparatus is not limited to this. The information processing apparatus can be a smartphone, a tablet terminal, or a PC as an information processing apparatus connected to a head-mounted display device by wire or wireless. In this case, part of processing described below that is executed by an HMD can be executed by the information processing apparatus connected to the head-mounted display device by wire or wireless.

The information processing apparatus A100 includes a control unit A101, a storage unit A102, a memory A103, an input unit A104, an output unit A105, a sensor A106, and a communication unit A107.

The control unit A101 controls each unit of the information processing apparatus A100. The control unit A101 executes a program stored in the storage unit A102, makes use of the memory A103 as a work area, and thus controls the entire processing units of the information processing apparatus A100. The control unit A101 includes at least one central processing unit (CPU), which executes the program stored in the storage unit A102, and at least one circuit. Furthermore, the control unit A101 can be configured with, for example, one or a plurality of processors, such as CPUs or graphics processing units (GPUs). Furthermore, instead of the control unit A101 controlling the entire information processing apparatus A100, a plurality of pieces of hardware can share the processing and thus control the entire information processing apparatus A100.

The storage unit A102 is, for example, an electrically erasable and recordable non-volatile storage medium, such as a solid state drive (SSD) or flash memory, in which, for example, in addition to the program which is executed by the control unit A101, a database and user settings are stored.

The memory A103 is, for example, a random access memory (RAM), and is used as, for example, a buffer memory for temporarily storing various pieces of data and a control area for the control unit A101.

The input unit A104 is used for the user to input an instruction to the information processing apparatus A100.

The input unit A104 includes, for example, a power button that is used for the user to issue an instruction for powering-on and powering-off the information processing apparatus A100 and an operation button that is used for the user to issue an instruction for screen transition. Furthermore, the input unit A104 does not necessarily need to be incorporated in the information processing apparatus A100. The input unit A104 can be a configuration which performs inputting via the communication unit A107 described below with use of, for example, a controller. Furthermore, the input unit A104 can be a configuration that inputs an instruction to the information processing apparatus A100 via, in addition to buttons, at least any one of an operation input performed by a gesture recognized from, for example, an image, a voice input, and a line-of-sight input (gaze input).

The output unit A105 is, for example, a graphical user interface (GUI) for an interactive operation, a light emission device (e.g., a light-emitting diode (LED)), or a sound output device (e.g., a loudspeaker). Furthermore, the output unit A105 can be configured to perform outputting via the communication unit A107 described below.

The sensor A106 includes, for example, an image capturing sensor, which captures a nearby video image, a light detection and ranging (LiDAR) sensor, which measures a nearby situation, or a time of flight (ToF) sensor. Additionally, the sensor A106 includes, for example, an inertial measurement unit (IMU) sensor, which is used for posture or position measurement, or a geomagnetic sensor. Furthermore, the sensor A106 does not necessarily need to be incorporated in the information processing apparatus A100.

The communication unit A107 includes, for example, a serial bus or parallel bus, which is used for connecting to another apparatus. Additionally, the communication unit A107 includes, for example, a connector (RJ45) for connecting to Ethernet, a network interface card (NIC) having, for example, a communication integrated circuit (IC) incorporated therein, or a communication unit used for performing wireless connection with a controller or external equipment.

While the configuration of a terminal has been described above with an HMD assumed to be the information processing apparatus A100, the above-described configuration of a terminal is merely an example, and the information processing apparatus A100 does not need to be an HMD and the configuration of a terminal can be a different configuration.

### Method for Evaluating Likelihood of an Occurrence of an Erroneous Operation

In the following description, a method for evaluating the likelihood of an occurrence of an erroneous operation when an input operation has been performed on a CG object in the first embodiment is described. The reason for evaluating the likelihood of an occurrence of an erroneous operation is that such a likelihood becomes a factor of one of methods for, in a case where an input operation has been performed on a CG object, determining whether to relocate the CG object or to execute processing corresponding to the input operation.

Conceivable points of view of evaluating the likelihood of an occurrence of an erroneous operation include, for example, the size of a CG object, the orientation of a CG object, and the distance or positional relationship between the user and a CG object.

### Method for Evaluating Likelihood of an Occurrence of an Erroneous Operation: Size of CG Object

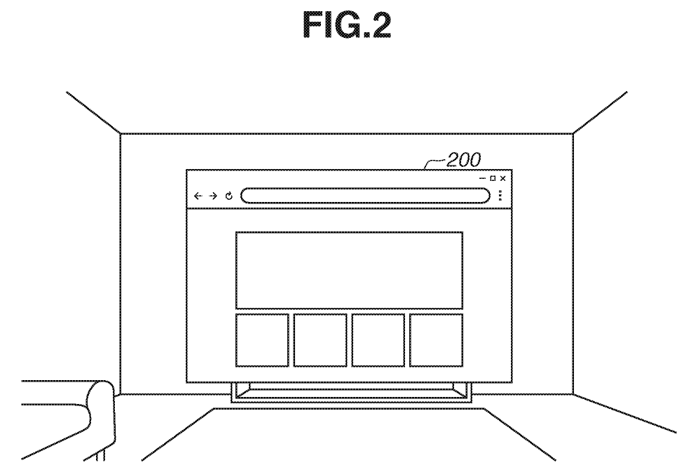

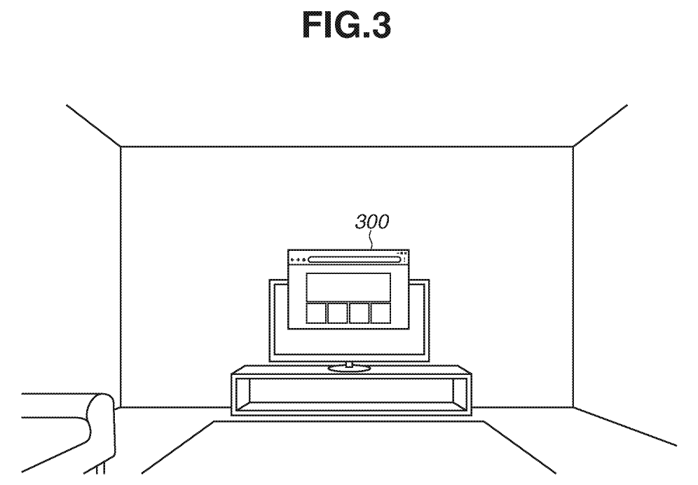

In the following description, a method for evaluating the likelihood of an occurrence of an erroneous operation from the viewpoint of the size of a CG object is described with reference to FIG. 2 and FIG. 3.

FIG. 2 is a diagram representing how a CG object 200 looks to the user in a case where the CG object 200 is in an appropriate location (appropriate size, position, and orientation). If the CG object 200 is displayed at an appropriate size, user interface (UI) parts on the CG object 200 are also displayed at respective appropriate sizes, so that it is possible to accurately perform an operation intended by the user with use of, for example, a line of sight input or a ray operation. Moreover, FIG. 3 is a diagram representing how a CG object 300 looks to the user in a case where the CG object 300 is small and is displayed at an inappropriate size. In a case where the CG object 300 is too small as illustrated in FIG. 3, UI parts displayed on the CG object 300 are also small, so that it becomes difficult to accurately, without any erroneous operation, perform an operation intended by the user with use of, for example, a line of sight input or a ray operation.

As one of the indicators, depending on an HMD, a design guide concerning UI displaying adapted to the HMD may be presented by the manufacturer of the HMD. In a case where a UI is in the state of being displayed far away from the design guide, it is difficult to perform an input operation, so that it is possible to evaluate that the CG object is in a state in which an erroneous operation is likely to occur. For example, in a case where the design guide states that the display size of a button should be greater than or equal to 60 points (pt), whether the size of the button on the CG object is greater than or equal to 60 pt, stated in the design guide, only needs to be checked. If the size of the displayed button is less than 60 pt, it is possible to evaluate that the CG object is in a state in which an erroneous operation is likely to occur.

The above-mentioned method for evaluating the likelihood of an occurrence of an erroneous operation from the viewpoint of the size of a CG object is merely an example, and can be a different method as long as it is capable of evaluating the likelihood of an occurrence of an erroneous operation.

### Method for Evaluating Likelihood of an Occurrence of an Erroneous Operation: Position of CG Object

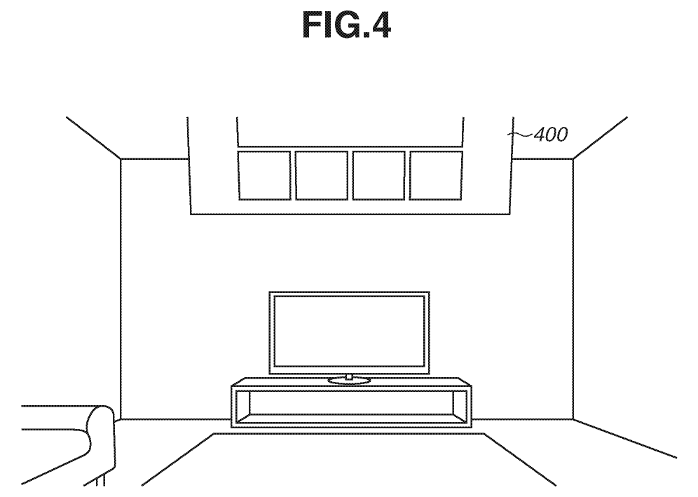

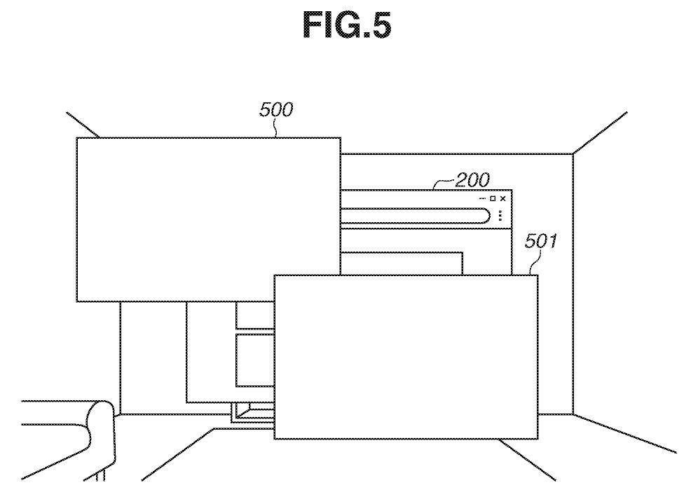

In the following description, a method for evaluating the likelihood of an occurrence of an erroneous operation from the viewpoint of the position of a CG object is described with reference to FIG. 4 and FIG. 5.

While some methods for evaluating the likelihood of an occurrence of an erroneous operation from the viewpoint of the position of a CG object are conceivable, in the first embodiment, three methods which seem more important from among the conceivable methods are described.

First, the first method is a method for evaluating the likelihood of an occurrence of an erroneous operation based on the distance between the user and a CG object. With regard to the distance between the user and a CG object, as the distance between the user and the CG object becomes longer, the apparent size off the CG object becomes smaller, so that it is possible to perform evaluation as with the evaluation for the likelihood of an occurrence of an erroneous operation from the viewpoint of the size of a CG object.

Next, the second method is a method for evaluating the likelihood of an occurrence of an erroneous operation based on the height of a CG object. FIG. 4 is a diagram representing how a CG object 400 looks to the user in a case where the CG object 400 is located at a position higher than the eye level of the user.

In general, if a CG object is displayed at the eye level of the user, the user is able to visually recognize the CG object in a comfortable position. On the other hand, in a case where a CG object 400 is displayed at a position clearly higher than the eye level as illustrated in FIG. 4, the user need to perform an operation with the user’s head up, so that it can be said that, as the more the posture becomes unreasonable, a state in which an erroneous operation is likely to occur appears more frequently. To evaluate whether a CG object is in a state in which an erroneous operation is likely to occur, for example, in a case where, when the threshold values of the angle of the head are set to 15 degrees up and down, it is necessary to tilt the head beyond the threshold values, it can be evaluated that the CG object is in a state in which an erroneous operation is likely to occur.

Lastly, the third method is a method for evaluating the likelihood of an occurrence of an erroneous operation based on whether there is an obstacle between the user and a CG object. FIG. 5 is a diagram representing how a CG object 200 looks to the user in a case where, in front of the CG object 200, another CG object is located as an obstacle.

In a case where there is an obstacle between the user and a CG object 200, a part or the whole of the CG object 200 is hidden by the obstacle (obstacle 500, obstacle 501) as illustrated in FIG. 5 and thus becomes unable to be visually recognized. Since, when trying to perform an input operation on the CG object, the user has to perform the input operation while keeping away from the obstacle, it can be said that a state in which an erroneous operation is likely to occur is appearing. To evaluate whether a CG object is in a state in which an erroneous operation is likely to occur, for example, in a case where a CG object is hidden beyond the threshold value for the proportion in which there is no trouble even if the CG object is hidden, it can be evaluated that the CG object is in a state in which an erroneous operation is likely to occur. For example, such a threshold value to be set can be 25%. Furthermore, in a case where another CG object is arranged in a portion on which the user performs an operation, even if the CG object concerned is not too hidden, it can be determined that the likelihood of an occurrence of an erroneous operation is high. Therefore, it can also be evaluated (determined) whether a UI for input operation prepared for a CG object is being hidden by another CG object or whether the distance between respective UIs of a plurality of CG objects is smaller than a predetermined distance.

With regard to the above-mentioned method for evaluating the likelihood of an occurrence of an erroneous operation from the viewpoint of the position of a CG object, since the evaluation result varies depending on the position of the user changing, it is necessary to perform calculations in consideration of the position of the user. Moreover, the above-mentioned method is merely an example, and can be a different method as long as it is capable of evaluating the likelihood of an occurrence of an erroneous operation.

### Method for Evaluating Likelihood of an Occurrence of an Erroneous Operation: Orientation of CG Object

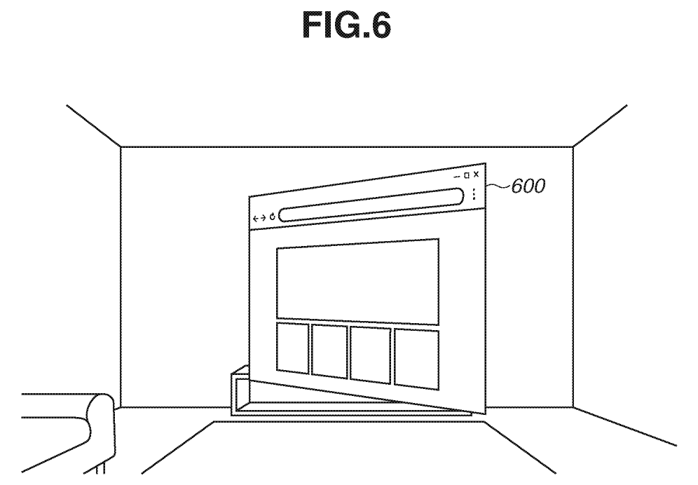

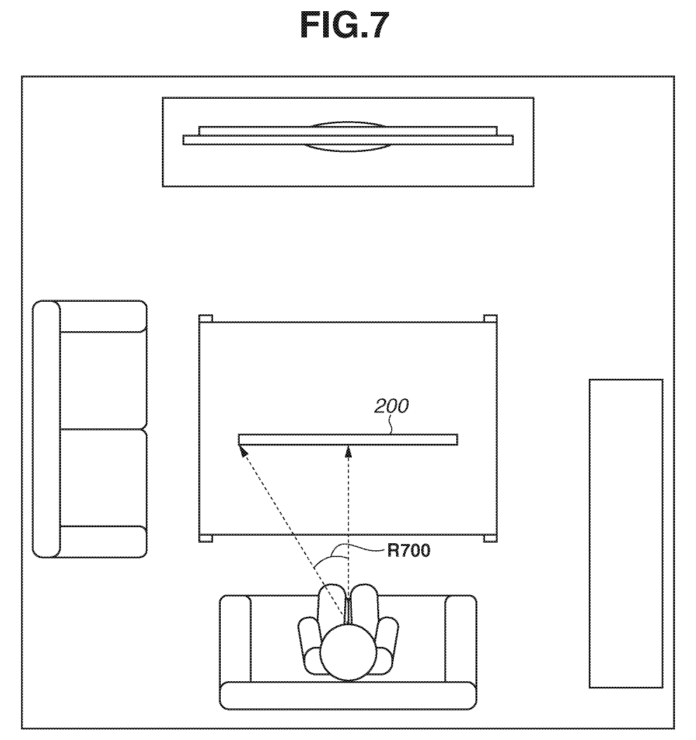

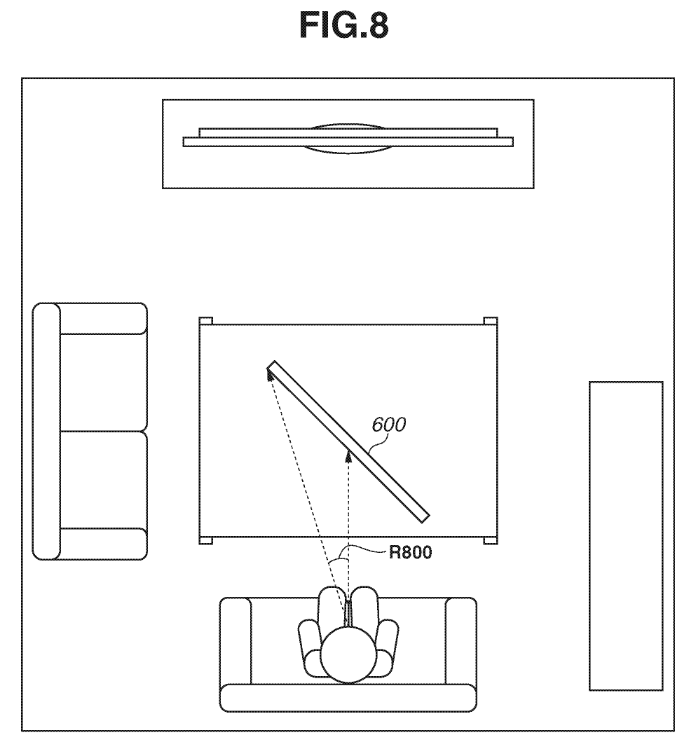

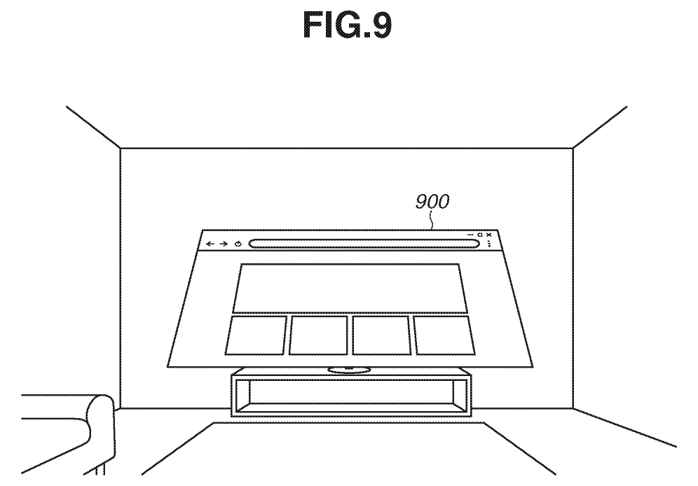

In the following description, a method for evaluating the likelihood of an occurrence of an erroneous operation from the viewpoint of the orientation of a CG object is described with reference to FIG. 6, FIG. 7, FIG. 8, and FIG. 9.

FIG. 6 is a diagram representing how a CG object 600 looks to the user in a case where the CG object 600 is located obliquely in the yaw direction relative to the user. Thus, FIG. 6 is a diagram representing a state in which the CG object 600 is not facing the front. Specifically, FIG. 6 is a diagram representing a state in which, from the user's point of view, the right-hand side of the CG object is at the near side and the left-hand side of the CG object is at the far side. Moreover, FIG. 7 is a diagram representing a space obtained when the space illustrated in FIG. 2 is viewed from an overhead viewpoint, and FIG. 8 is a diagram representing a space obtained when the space illustrated in FIG. 6 is viewed from an overhead viewpoint. Moreover, FIG. 9 is a diagram representing how a CG object 900 looks to the user in a case where the CG object 900 is located obliquely in the pitch direction relative to the user. Thus, FIG. 9 is a diagram representing a state in which the CG object 900 is facing the front relative to the user and the CG object 900 is arranged in such a way as to look leaning toward the far side from the user's point of view.

Here, a method for evaluating the likelihood of an occurrence of an erroneous operation from the viewpoint of the orientation in the yaw direction of a CG object is described with reference to FIG. 7 and FIG. 8.

An angle R700 illustrated in FIG. 7 is an angle formed by three points, i.e., the center of a CG object 200, the position of the user, and the left end of the CG object 200.

An angle R800 illustrated in FIG. 8 is an angle formed by three points, i.e., the center of a CG object 600, the position of the user, and the left end of the CG object 600.

Comparing the angle R700 and the angle R800, since, while the CG object 200 is arranged to face the front relative to the user, the CG object 600 is arranged obliquely from the user's point of view, it can be seen that the angle R800 is smaller than the angle R700. Supposing a case where the user has moved, by a predetermined angle, a position used for issuing an instruction for designating a predetermined position, in the case illustrated in FIG. 8, the amount of movement of the position used for issuing an instruction on the CG object becomes larger than in the case illustrated in FIG. 7. In other words, in the case of selecting a UI on a CG object by a line of sight input or a ray operation, since the arrangement of the CG object illustrated in FIG. 8 makes the amount of movement on the CG object relative to the same angle larger than the arrangement of the CG object illustrated in FIG. 7, it can be said that the arrangement of the CG object illustrated in FIG. 8 is in a state in which an erroneous operation is more likely to occur. For example, when the user wants to minutely perform an operation, fine adjustment becomes difficult, so that there is a concern that an erroneous operation may occur. Besides, since, compared with a case where a CG object is arranged to face forward (face the front), the case where a CG object is arranged obliquely relative to the user makes the area of, for example, a button available for an operation input from the user's point of view smaller, there is a concern that an erroneous operation may occur. While the CG object 600 illustrated in FIG. 8 is arranged at a position obtained by rotating the CG object 200 illustrated in FIG. 7 by 45 degrees, since, as the angle of rotation comes close to 90 degrees, the amount of movement relative to the angle becomes larger, it can be said that a state in which an erroneous operation is more likely to occur appears.

Moreover, while FIG. 6 is a diagram representing a state in which the CG object 600 has been rotated in the yaw direction in such a way as to be arranged obliquely relative to the user, even in a case where the CG object 900 has been rotated in the pitch direction in such a way as to be arranged obliquely relative to the user as illustrated in FIG. 9, it can be similarly said that, as the angle of rotation comes close to 90 degrees, a state in which an erroneous operation is more likely to occur appears.

To evaluate whether a CG object is in a state in which an erroneous operation is likely to occur, for example, the threshold value of the angle of a CG object is set to 15 degrees with respect to each of the yaw direction and the pitch direction (with the angle obtained when the CG object faces the front relative to the user being set to 0 degrees). Then, in a case where the CG object is arranged obliquely beyond the threshold value, it can be evaluated that the CG object is in a state in which an erroneous operation is likely to occur. Furthermore, in a case where the threshold value is exceeded, a similar evaluation result can be employed, and an evaluation result in which, in a case where the threshold value is exceeded, as the difference from the threshold value becomes larger, an erroneous operation is more likely to occur can be employed.

Since the orientation of a CG object also varies depending on the posture (position or orientation) of the user who observes the CG object changing, it is necessary to calculate the orientation of the CG object in the user's point of view.

The above-mentioned method for evaluating the likelihood of an occurrence of an erroneous operation from the viewpoint of the orientation of a CG object is merely an example, and can be a different method as long as it is capable of evaluating the likelihood of an occurrence of an erroneous operation.

### Method for Determining Whether to Relocate CG Object or to Execute Processing Corresponding to Input Operation

In the following description, a method for determining whether to relocate a CG object or to execute processing corresponding to an input operation in the first embodiment is described.

In a case where an input operation has been performed on a CG object, based on whether the CG object is in a state in which an erroneous operation is likely to occur, it can be determined whether to relocate the CG object or to execute processing corresponding to the input operation.

In the first embodiment, in a case where an input operation has been performed on a CG object, from the above-mentioned plurality of viewpoints, such as the size or orientation of the CG object or the distance or positional relationship between the user and the CG object, whether the CG object is in a state in which an erroneous operation is likely to occur is evaluated. Then, in a case where, from any one of the viewpoints, it has been evaluated that CG object is in a state in which an erroneous operation is likely to occur, it is determined to relocate the CG object. In a case where, from all of the viewpoints, it has not been evaluated that the CG object is in a state in which an erroneous operation is likely to occur, it is determined to directly execute processing corresponding to the input operation performed on the CG object.

The above-mentioned method for determining whether to relocate a CG object or to execute processing corresponding to an input operation is merely an example, and can be a different method as long as it is capable of determining whether to relocate a CG object or to execute processing corresponding to an input operation.

### Method for Relocating CG Object

In the following description, a method for relocating a CG object in the first embodiment is described.

In a case where, by the above-mentioned method for determining whether to relocate a CG object or to execute processing corresponding to an input operation, it is determined to relocate a CG object, in the first embodiment, the relocation of a CG object is performed as follows.

In a case where it is determined that the relocation of a CG object is necessary, the relocation of a CG object is performed in such a manner that the CG object comes into a state in which an erroneous operation is unlikely to occur. In a case where an input operation has been performed again after the relocation of the CG object, it is expected that the relocation of the CG object has been previously performed in such a manner that, without the need for the relocation of the CG object, processing corresponding to the input operation is executed.

It is expected that, as with the CG object 200 illustrated in FIG. 2, the CG object which has been relocated is displayed at an appropriate size and is arranged at an appropriate position and orientation based on the posture (position or orientation) of the user. Here, the appropriate size is, for example, a size which decreases the possibility that an erroneous operation different from an operation which the user supposes occurs. The size which decreases the possibility that an erroneous operation occurs can be determined based on, for example, an indicator such as a pointer or ray indicating the position which the user designates. In a case where a button is smaller than the size of the pointer, an erroneous operation is likely to occur and it is thus determined that the CG object is not currently displayed at an appropriate size. Moreover, in a case where the button is somewhat larger than the size of the button, it can be determined that the CG object is currently displayed at an appropriate size. For example, in a case where, with regard to a controller, the user performs a selection operation or determination operation via a button of the controller, even when the position gap of a pointer of the controller occurs by the button operation, if the button is currently displayed at a size large enough to make an erroneous operation unlikely to occur, it can be determined that the CG object is currently displayed at an appropriate size.

In the first embodiment, the relocation of a CG object is performed in such a manner that the CG object is displayed at a position which is at a distance within the reach of the user, near the front from the user's point of view, not blocked by an obstacle, and at the same height as the eye level, facing the front relative to the user, and with the same size as the original size. Since the distance within the reach of the user varies depending on the length of the arm of the user, it is ideal that a value obtained by tuning for the individual users is used as the distance, but in the first embodiment, the distance is uniformly set to 50 centimeters (cm). While, even in a case where the size of the CG object is set as the same size as the original size, depending on the formation of the CG object, the CG object may not be displayed at an optimum size, in the description of the first embodiment, it is assumed that, when the CG object is displayed at the same size as the original size, the CG object is displayed at an appropriate size.

The above-mentioned method for relocating a CG object is merely an example, and can be a different method as long as it is capable of relocating a CG object.

### Method for Executing Processing Corresponding to Input Operation on CG Object

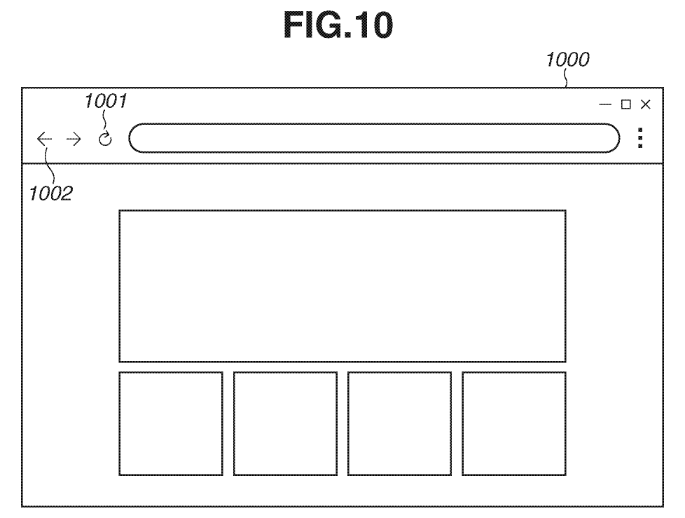

In the following description, a method for executing processing corresponding to an input operation on a CG object in the first embodiment is described with reference to FIG. 10.

In a case where, by the above-mentioned method for determining whether to relocate a CG object or to execute processing corresponding to an input operation, it is determined to execute processing corresponding to an input operation on a CG object, in the first embodiment, processing is executed as follows.

FIG. 10 is a diagram illustrating a CG object 1000 equipped with user interface (UI) parts serving as a browser. The CG object 1000 is configured with a plurality of UI parts, including, for example, a refresh button 1001 and a back button 1002.

For example, in a case where an input operation (tap operation) has been performed on the refresh button 1001 of the CG object 1000, the CG object 1000 operates to execute refresh processing for pages. In a case where an input operation (tap operation) has been performed on the back button 1002 of the CG object 1000, the CG object 1000 operates to display a page which the CG object 1000 has just previously displayed.

Thus, executing processing corresponding to an input operation on a CG object refers to performing an operation mounted in the CG object as usual.

### Flow for Determining Whether to Perform Relocation or to Execute processing Corresponding to Input Operation

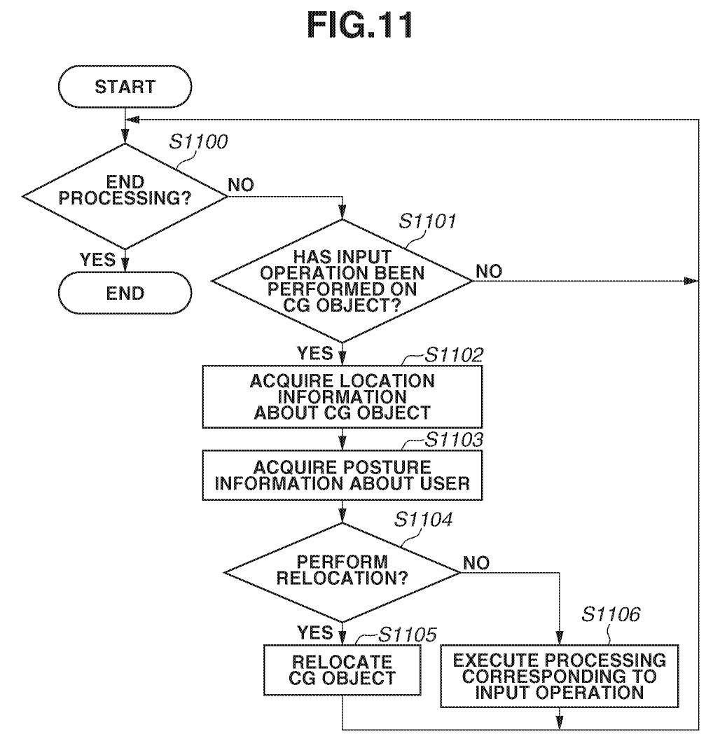

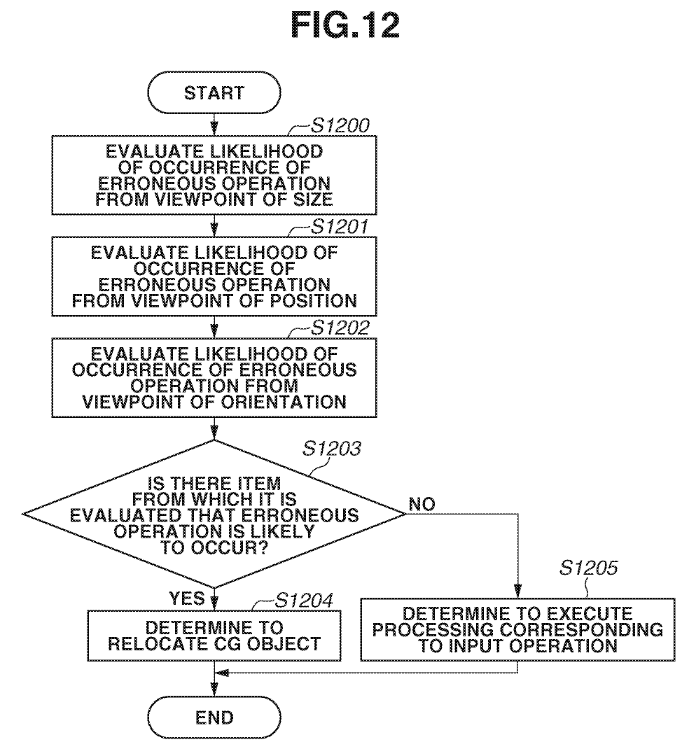

In the following description, the details of an operation of the information processing apparatus in the first embodiment are described with reference to FIG. 11 and FIG. 12.

FIG. 11 and FIG. 12 are flowcharts illustrating processing which the information processing apparatus A100 executes in the first embodiment. Processing in the flowchart of FIG. 11 is started in response to a starting operation for a system or application which performs display control of a CG object being performed.

In step S1100, the control unit A101 determines whether to end processing, based on the state of each unit of the information processing apparatus A100. For example, in a case where an ending operation has been performed via the input unit A104 (YES in step S1100), the control unit A101 ends the processing in the present flowchart. If it is determined to continue the processing (NO in step S1100), the control unit A101 advances the processing to step S1101.

In step S1101, the control unit A101 determines whether an input operation has been performed on any CG object via the input unit A104. If it is determined that an input operation has been performed on a CG object (YES in step S1101), the control unit A101 advances the processing to step S1102. Moreover, if it is not determined that an input operation has been performed on a CG object (NO in step S1101), the control unit A101 returns the processing to step S1100.

In step S1102, the control unit A101 acquires location information about a CG object on which an input operation has been performed in step S1101. The location information is assumed to include at least any one of pieces of information about the size, position, and orientation of the CG object.

In step S1103, the control unit A101 acquires posture information about the user. The posture of the user is the posture of the head of the user, and, since the information processing apparatus A100 serving as an HMD is worn on the head of the user, the control unit A101 only needs to acquire posture information about the information processing apparatus A100 as the posture information about the user. The posture information is assumed to include at least any one of pieces of information about the position and orientation. Furthermore, for example, in a case where an external camera is arranged within a space as in the Outside-In method, the control unit A101 can be configured to acquire the user's own posture information. In this case, the control unit A101 can use, for example, Simultaneous Localization and Mapping (SLAM) to detect the direction of the front of the user based on the orientation of a predetermined region such as the body or leg of the user and acquire the detected direction as the posture of the user.

In step S1104, the control unit A101 evaluates the likelihood of an occurrence of an erroneous operation on the CG object on which an input operation has been performed in step S1101 and determines whether to relocate the CG object or to execute processing corresponding to the input operation. The method for determining whether to relocate the CG object or to execute processing corresponding to the input operation is as described above. The control unit A101 evaluates the likelihood of an occurrence of an erroneous operation with use of the values of the location information about the CG object acquired in step S1102 and the posture information about the user acquired in step S1103, and uses a result of the evaluation to determine whether to relocate the CG object. If it is determined to relocate the CG object (YES in step S1104), the control unit A101 advances the processing to step S1105. Moreover, if it is determined to execute processing corresponding to the input operation (NO in step S1104), the control unit A101 advances the processing to step S1106. The processing operation in step S1104 is equivalent to processing in the flow illustrated in FIG. 12, and the details thereof are described below.

In step S1105, the control unit A101 performs the relocation of the CG object on which an input operation has been performed in step S1101. The relocation of the CG object is as described above, and the control unit A101 determines location information (size, position, and location) of the CG object obtained by the relocation with use of the value of the posture information of the user acquired in step S1103, and thus performs the relocation.

In step S1106, with respect to the CG object on which an input operation has been performed in step S1101, the control unit A101 executes processing corresponding to the input operation on the CG object. The method for executing processing corresponding to the input operation on the CG object is as described above.

### Method for Determining Whether to Perform Relocation

FIG. 12 is a flowchart illustrating the details of processing which the information processing apparatus A100 executes to determine whether to perform the relocation of a CG object or to execute processing corresponding to an input operation in the first embodiment. Processing operations in step S1200 to step S1205 in the flowchart of FIG. 12 are equivalent to the processing operation in step S1104 illustrated in FIG. 11.

In step S1200, the control unit A101 evaluates the likelihood of an occurrence of an erroneous operation on a CG object from the viewpoint of the size based on the values of the location information about the CG object acquired in step S1102 and the posture information about the user acquired in step S1103. The method for evaluating the likelihood of an occurrence of an erroneous operation on a CG object from the viewpoint of the size is as described above. The control unit A101 stores a result of the evaluation in the memory A103 and refers to the stored result in step S1203 described below.

In step S1201, the control unit A101 evaluates the likelihood of an occurrence of an erroneous operation on a CG object from the viewpoint of the position based on the values of the location information about the CG object acquired in step S1102 and the posture information about the user acquired in step S1103. The method for evaluating the likelihood of an occurrence of an erroneous operation on a CG object from the viewpoint of the position is as described above. The control unit A101 stores a result of the evaluation in the memory A103 and refers to the stored result in step S1203 described below.

In step S1202, the control unit A101 evaluates the likelihood of an occurrence of an erroneous operation on a CG object from the viewpoint of the orientation based on the values of the location information about the CG object acquired in step S1102 and the posture information about the user acquired in step S1103. The method for evaluating the likelihood of an occurrence of an erroneous operation on a CG object from the viewpoint of the orientation is as described above. The control unit A101 stores a result of the evaluation in the memory A103 and refers to the stored result in step S1203 described below.

In step S1203, the control unit A101 acquires, via the memory A103, the values of the likelihood of an occurrence of an erroneous operation evaluated in the respective processing operations in step S1200 to step S1202, and, based on the acquired values, determines whether to relocate the CG object. If it is determined that the CG object is evaluated to be in a state in which an erroneous operation is likely to occur from any one of the viewpoints (YES in step S1203), the control unit A101 advances the processing to step S1204 for the purpose of relocating the CG object. If it is determined that the CG object is not evaluated to be in a state in which an erroneous operation is likely to occur from any one of the viewpoints (NO in step S1203), the control unit A101 advances the processing to step S1205.

In step S1204, the control unit A101 determines to execute processing to relocate the CG object. Thus, the control unit A101 determines to advance the processing to step S1105 in the flow illustrated in FIG. 11.

In step S1205, the control unit A101 determines to execute processing corresponding to the input operation. Thus, the control unit A101 determines to advance the processing to step S1106 in the flow illustrated in FIG. 11.

As described above, in a case where an input operation has been performed by the user on a CG object, if there is a situation in which an erroneous operation is likely to occur, the information processing apparatus A100 relocates the CG object in such a manner that the situation changes to a situation in which an erroneous operation is unlikely to occur. Moreover, if there is no situation in which an erroneous operation is likely to occur, the information processing apparatus A100 switches processing in such a way as to execute processing corresponding to the input operation.

This enables, in an input operation on a three-dimensional space such as an HMD, preventing the occurrence of an erroneous operation and performing operations which match the user's intentions.

### Second Embodiment

In the above-described first embodiment, with regard to the relocation of a CG object, the CG object is relocated in such a manner that the CG object is displayed at the front of the user and at an appropriate size, position, and orientation.

However, in a case where the factor of the likelihood of an occurrence of an erroneous operation is only the size, the size only needs to be changed at the time of relocation of the CG object. Similarly, in a case where the factor of the likelihood of an occurrence of an erroneous operation is only the position or orientation, the position or orientation only needs to be changed at the time of relocation of the CG object.

Rather than changing all of the factors, i.e., size, position, and orientation, at the time of relocation of the CG object, changing only the factor of the likelihood of an occurrence of an erroneous operation makes the amount of change between before and after the relocation of the CG object smaller, so that the user experience is expected to be improved.

Therefore, in a second embodiment, an operation which the information processing apparatus A100 performs in a case where, when an input operation has been performed on a CG object, there is only one factor of the likelihood of an occurrence of an erroneous operation is described.

Furthermore, in the second embodiment, since there are many portions in common with those in the first embodiment, portions specific to the second embodiment are mainly described.

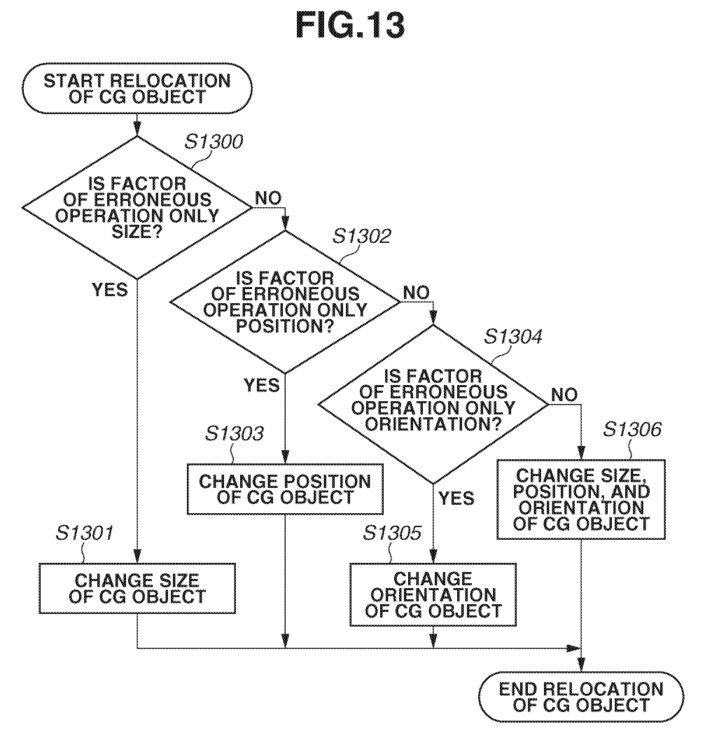

In the following description, a method for relocating a CG object in the second embodiment is described with reference to FIG. 13.

With regard to the relocation of a CG object in the second embodiment, processing for relocation is switched with use of a result of evaluation for the likelihood of an occurrence of an erroneous operation which has been used to determine whether to perform relocation. In a case where it has been evaluated that an erroneous operation is likely to occur only in a specific viewpoint, processing for changing the CG object corresponding to the viewpoint is performed, and, in other cases, the relocation of the CG object is performed in a method similar to that in the first embodiment.

FIG. 13 is a flowchart illustrating the details of processing which the information processing apparatus A100 executes to relocate a CG object in the second embodiment. The processing operations in the flowchart of FIG. 13 are performed in the processing operation in step S1105 illustrated in FIG. 11.

In step S1300, the control unit A101 refers to the memory A103 and checks whether, in step S1200, it has been evaluated that an erroneous operation is likely to occur only in the viewpoint of the size. If it is determined that it has been evaluated that an erroneous operation is likely to occur only in the viewpoint of the size (YES in step S1300), the control unit A101 advances the processing to step S1301. If it is determined otherwise (NO in step S1300), the control unit A101 advances the processing to step S1302.

In step S1301, the control unit A101 changes the size of the CG object.

The size of the CG object can be changed to, for example, the same size as the original size in such a way as not to be evaluated to be in a state in which an erroneous operation is likely to occur from the viewpoint of the size in a case where an input operation has been performed again.

In step S1302, the control unit A101 refers to the memory A103 and checks whether, in step S1201, it has been evaluated that an erroneous operation is likely to occur only in the viewpoint of the position. If it is determined that it has been evaluated that an erroneous operation is likely to occur only in the viewpoint of the position (YES in step S1302), the control unit A101 advances the processing to step S1303. If it is not determined that it has been evaluated that an erroneous operation is likely to occur only in the viewpoint of the position (NO in step S1302), the control unit A101 advances the processing to step S1304.

In step S1303, the control unit A101 changes the position of the CG object. The position of the CG object can be changed to, for example, a position which is at a distance within the reach of the user, near the front from the user's point of view, not blocked by an obstacle, and at the same height as the eye level in such a way as not to be evaluated to be in a state in which an erroneous operation is likely to occur from the viewpoint of the position in a case where an input operation has been performed again. Since the distance within the reach of the user varies depending on the length of the arm of the user, it is ideal that a value obtained by tuning for the individual users is used as the distance, but in the second embodiment, the distance is uniformly set to 50 cm as with the first embodiment.

In step S1304, the control unit A101 refers to the memory A103 and checks whether, in step S1202, it has been evaluated that an erroneous operation is likely to occur only in the viewpoint of the orientation. If it is determined that it has been evaluated that an erroneous operation is likely to occur only in the viewpoint of the orientation (YES in step S1304), the control unit A101 advances the processing to step S1305. If it is determined otherwise (NO in step S1304), the control unit A101 advances the processing to step S1306.

In step S1305, the control unit A101 changes the orientation of the CG object. The orientation of the CG object can be changed to, for example, facing the front relative to the user in such a way as not to be evaluated to be in a state in which an erroneous operation is likely to occur from the viewpoint of the orientation in a case where an input operation has been performed again.

In step S1306, the control unit A101 changes the size, position, and orientation of the CG object. The CG object is relocated in a manner similar to that in the first embodiment in such a way as not to be evaluated to be in a state in which an erroneous operation is likely to occur from all of the viewpoints in a case where an input operation has been performed on the CG object again. For example, the CG object can be displayed at a position which is at a distance within the reach of the user, near the front from the user's point of view, not blocked by an obstacle, and at the same height as the eye level, facing the front relative to the user, and with the same size as the original size.

As described above, in a case where an input operation has been performed by the user on a CG object, if there is only one factor of the likelihood of an occurrence of an erroneous operation, the information processing apparatus A100 in the second embodiment performs the relocation of the CG object in such a way as to change only that factor.

In the above-described first embodiment, at the time of the relocation of a CG object, the information processing apparatus A100 changes all of the factors, i.e., the size, position, and orientation of the CG object. On the other hand, the relocation of a CG object in the second embodiment makes the amount of change between before and after the relocation of the CG object smaller than that in the first embodiment, so that the user experience is expected to be improved.

### Third Embodiment

In the above-described second embodiment, at the time of relocation of a CG object, only a factor of the likelihood of an occurrence of an erroneous operation is changed. However, depending on the type or location condition of a CG object, there is a case where it is better to solve the likelihood of an occurrence of an erroneous operation by changing a factor different from the factor of the likelihood of an occurrence of an erroneous operation.

For example, in a case where the size of a CG object is fixed, the size of the CG object being varied by the relocation of the CG object is not favorable to the user.

In that case, it is better to perform relocation in such a way as to change not the size but the position of the CG object.

Similarly, in a case where the position or orientation of a CG object is fixed, the position or orientation of the CG object being varied by the relocation of the CG object is not favorable to the user. In that case, it is also favorable to perform relocation in such a way as to change another parameter such as the position or orientation of the CG object.

Therefore, in a third embodiment, an operation which the information processing apparatus A100 performs to switch the method for relocation of a CG object depending on the type or location condition of the CG object is described using, as an example, a case where the size of the CG object is fixed.

Furthermore, in the third embodiment, since there are many portions in common with those in the first embodiment and the second embodiment, portions specific to the third embodiment are mainly described.

### Method for Evaluating Likelihood of an Occurrence of an Erroneous Operation from Viewpoint of Position of CG Object

In the following description, a method for evaluating the likelihood of an occurrence of an erroneous operation from the viewpoint of the position of a CG object in the third embodiment is described.

The method for evaluating the likelihood of an occurrence of an erroneous operation from the viewpoint of the position of a CG object in the third embodiment is the same in basic concept as that in the first embodiment.

However, since, as a difference from the first embodiment, there is a condition of the size of a CG object being fixed, in the case of evaluating the likelihood of an occurrence of an erroneous operation using a distance between the user and a CG object, it is also necessary to take the fixed size of the CG object into consideration.

In the above-described first embodiment, in a case where it has been determined that an erroneous operation is likely to occur from the viewpoint of the size of a CG object, the size of the CG object is changed to an appropriate size by the relocation. Therefore, in the case of evaluating the likelihood of an occurrence of an erroneous operation from the viewpoint of the position of a CG object, the information processing apparatus A100 only needs to perform evaluation on the presupposition that the size of the CG object is appropriate. On the other hand, in the third embodiment, since a CG object is not necessarily fixed with an appropriate size, the information processing apparatus A100 calculates the apparent size of a CG object from the distance between the user and the CG object and the size of the CG object and then performs evaluation.

For example, in a case where the design guide has a description indicating that the display size of the button has to be 60 pt or more, to evaluate whether the CG object is in a state in which an erroneous operation is likely to occur, the information processing apparatus A100 only needs to check whether the apparent size of the button on the CG object is greater than or equal to the display size described in the design guide. If the display size of the button is less than 60 pt, the information processing apparatus A100 can evaluate that the CG object is in a state in which an erroneous operation is likely to occur.

The above-mentioned method for evaluating the likelihood of an occurrence of an erroneous operation from the viewpoint of the position of a CG object is merely an example, and can be a different method as long as it is capable of evaluating the likelihood of an occurrence of an erroneous operation.

### Flow for Determining Whether to Perform Relocation of CG Object or to Execute processing Corresponding to Input Operation

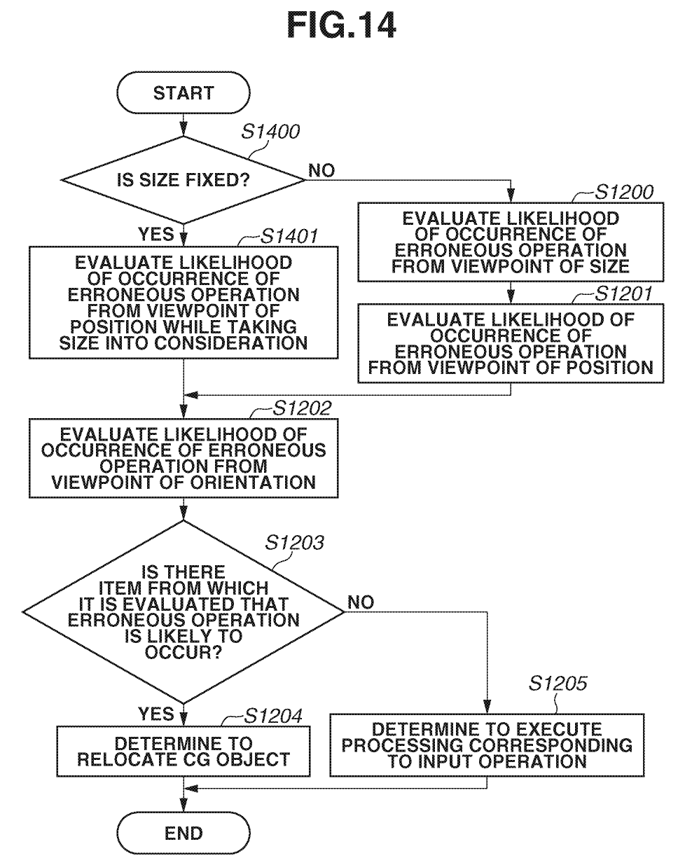

In the following description, a method for determining whether to relocate a CG object or to execute processing corresponding to an input operation in the third embodiment is described with reference to FIG. 14.

FIG. 14 is a flowchart illustrating the details of processing which the information processing apparatus A100 executes to determine whether to relocate a CG object in the third embodiment. Processing operations in the flowchart of FIG. 14 are equivalent to the processing operation in step S1104 illustrated in FIG. 11.

In step S1400, the control unit A101 refers to the memory A103 and determines whether the size of the CG object is fixed. If it is determined that the size of the CG object is fixed (YES in step S1400), the control unit A101 advances the processing to step S1401. If it is not determined that the size of the CG object is fixed (NO in step S1400), the control unit A101 advances the processing to step S1200.

In step S1401, the control unit A101 evaluates the likelihood of an occurrence of an erroneous operation from the viewpoint of the position while taking the size of the CG object into consideration based on the values of the location information about the CG object acquired in step S1102 and the posture information about the user acquired in step S1103.

The method for evaluating the likelihood of an occurrence of an erroneous operation from the viewpoint of the position while taking the size of the CG object into consideration is as described above. The control unit A101 stores a result of the evaluation in the memory A103 and refers to the stored result in step S1203 described below.

Furthermore, processing operations in step S1200 to step S1205 are similar to those described above with reference to FIG. 12 and are, therefore, omitted from description here.

In this way, in the present flow, if the size of a CG object which has been operated is fixed, the control unit A101 evaluates the likelihood of an occurrence of an erroneous operation from the viewpoint of other than the size, and, if the size of the CG object is not fixed, the control unit A101 evaluates the likelihood of an occurrence of an erroneous operation from the viewpoints including the size.

### Method for Changing Position of CG Object

In the following description, a method for changing the position of a CG object in the third embodiment is described.

In the above-mentioned method of relocating a CG object in the first embodiment and the second embodiment, the position of the CG object is changed in such a manner that the distance from the user to the CG object in the front of the user and at the height of the eye level becomes 50 cm. However, in the third embodiment, the position of the CG object is changed in such a manner that such a distance becomes not 50 cm but a distance obtained in consideration of the size of the CG object.

In the third embodiment, a case where the size of a CG object is the same size as the original size is used as a basis. In a case where the size of a CG object is the same size as the original size, the information processing apparatus A100 changes the position of the CG object in such a manner that the distance between the user and the CG object becomes 50 cm as with the first embodiment. In the other cases, the information processing apparatus A100 changes the position of the CG object in such a manner that the apparent size of the CG object becomes the same as the size obtained in the case used as a basis.

In a case where the size of the CG object has become half, adjusting the distance between the CG object and the user to half maintains the apparent size of the CG object unchanged in perspective. For example, in a case where the size of the CG object is half the same size as the original size, the information processing apparatus A100 changes the position of the CG object in such a manner that the distance between the CG object and the user becomes a distance of 50 cm to 25 cm. In doing so, the information processing apparatus A100 is able to change the position of the CG object in such a manner that the apparent size of the CG object becomes the same as the size obtained in the case used as a basis.

In a case where the size of a CG object is another size, by using a similar concept using perspective, the information processing apparatus A100 is also able to obtain the destination position of the CG object.

The above-mentioned method for changing the position of a CG object is merely an example, and can be a different method as long as it is capable of changing the position of a CG object.

### Method of Relocation of CG Object

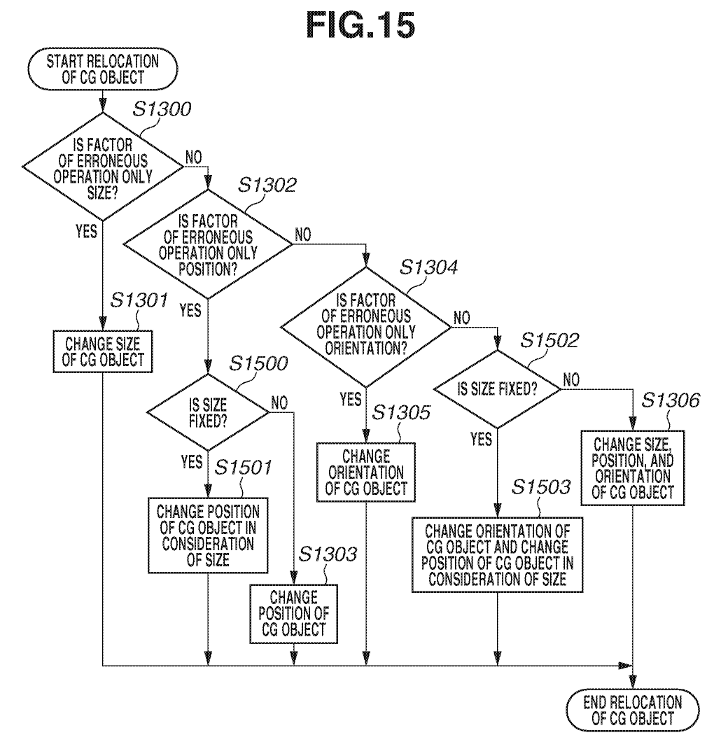

In the following description, a method for relocating a CG object in the third embodiment is described with reference to FIG. 15.

With regard to processing for the relocating a CG object in the third embodiment, processing for relocation is switched depending on whether the size of the CG object is fixed. If, at the time of changing the position of the CG object, the size of the CG object is fixed, changing the position of the CG object is performed in consideration of the size of the CG object. If not so, the position of the CG object is changed in a method similar to that in the second embodiment.

FIG. 15 is a flowchart illustrating the details of processing which the information processing apparatus A100 executes to relocate a CG object in the third embodiment. The processing operations in the flowchart of FIG. 15 are performed in the processing operation in step S1105 illustrated in FIG. 11.

Processing operations in step S1300 and step S1301 are similar to those described above with reference to FIG. 13 and are, therefore, omitted from description here.

In step S1302, the control unit A101 refers to the memory A103 and checks whether, in step S1201, it has been evaluated that an erroneous operation is likely to occur only in the viewpoint of the position. If it is determined that it has been evaluated that an erroneous operation is likely to occur only in the viewpoint of the position (YES in step S1302), the control unit A101 advances the processing to step S1500. If it is not determined that it has been evaluated that an erroneous operation is likely to occur only in the viewpoint of the position (NO in step S1302), the control unit A101 advances the processing to step S1304.

In step S1500, the control unit A101 refers to the memory A103 and determines whether the size of the CG object is fixed. If it is determined that the size of the CG object is fixed (YES in step S1500), the control unit A101 advances the processing to step S1501. If it is not determined that the size of the CG object is fixed (NO in step S1500), the control unit A101 advances the processing to step S1303.

In step S1501, the control unit A101 changes the position of the CG object in consideration of the size of the CG object based on the values of the location information about the CG object acquired in step S1102 and the posture information about the user acquired in step S1103. The method for changing the position of the CG object in consideration of the size of the CG object is as described above.

A processing operation in step S1303 is similar to that described above with reference to FIG. 13 and is, therefore, omitted from description here.

In step S1304, the control unit A101 refers to the memory A103 and determines whether, in step S1202, it has been evaluated that an erroneous operation is likely to occur only in the viewpoint of the orientation. If it is determined that it has been evaluated that an erroneous operation is likely to occur only in the viewpoint of the orientation (YES in step S1304), the control unit A101 advances the processing to step S1305. If it is not determined that it has been evaluated that an erroneous operation is likely to occur only in the viewpoint of the orientation (NO in step S1304), the control unit A101 advances the processing to step S1502.

A processing operation in step S1305 is similar to that described above with reference to FIG. 13 and is, therefore, omitted from description here.

In step S1502, the control unit A101 refers to the memory A103 and determines whether the size of the CG object is fixed. If it is determined that the size of the CG object is fixed (YES in step S1502), the control unit A101 advances the processing to step S1503. Moreover, if it is not determined that the size of the CG object is fixed (NO in step S1502), the control unit A101 advances the processing to step S1306.

In step S1503, the control unit A101 changes the orientation of the CG object and changes the position of the CG object in consideration of the size of the CG object. Here, the position of the CG object is changed based on the values of the location information about the CG object acquired in step S1102 and the posture information about the user acquired in step S1103. The method for changing the orientation of the CG object is the same as that in the first embodiment and the second embodiment, and the method for changing the position of the CG object in consideration of the size of the CG object is as described above.

A processing operation in step S1306 is similar to that described above with reference to FIG. 13 and is, therefore, omitted from description here.

As described above, in a case where the size of a CG object is fixed depending on the type or location condition of the CG object, the information processing apparatus A100 in the third embodiment performs relocation in such a way as to change the position of the CG object in consideration of the size of the CG object.

This enables, in a case where the size of a CG object is fixed, without changing the size of the CG object, relocating the CG object in such a manner that the CG object comes into a state in which an erroneous operation is unlikely to occur.

While, in the third embodiment, the case where the size of a CG object is fixed is described as an example, in a case where the position of a CG object is fixed, the information processing apparatus A100 only needs to perform relocation in such a way as to change the size of the CG object in consideration of the distance between the user and the CG object. Moreover, in a case where the orientation of a CG object is fixed, the information processing apparatus A100 only needs to perform the relocation of the CG object in such a way as to change the position of the CG object in consideration of the orientation of the CG object.

### Fourth Embodiment

In the above-described first embodiment, second embodiment, and third embodiment, in a case where an input operation has been performed on a CG object, the information processing apparatus A100 evaluates whether the CG object is in a state in which an erroneous operation is likely to occur from one or some viewpoints. Moreover, based on a result of the evaluation, the information processing apparatus A100 determines whether to relocate the CG object or to execute processing corresponding to the input operation.

However, in some cases, the information processing apparatus A100 may determine whether to relocate the CG object or to execute processing corresponding to the input operation from, besides the viewpoint of the likelihood of an occurrence of an erroneous operation, the viewpoint as to whether the user is at a distance available for touching the CG object.

In a case where the user and the CG object are away from each other by a predetermined distance or more, the user becomes unable to directly touch the CG object even when stretching out the user's arm, and thus becomes unable to perform an input operation by Direct Touch. While, in the case of wanting to use a line of sight input or a ray input, there will be no issue, in the case of wanting to perform an operation by Direct Touch, it is not desirable that Direct Touch is excluded from the options for an input operation, so that this may cause a decline in usability.

Therefore, in a fourth embodiment, a case where, when determining whether to relocate a CG object or to execute processing corresponding to an input operation, the information processing apparatus A100 takes into consideration whether there is a possibility that the user performs an input operation using Direct Touch on the CG object is described.

Furthermore, in the fourth embodiment, since there are many portions in common with those in the first embodiment, the second embodiment, and the third embodiment, portions specific to the fourth embodiment are mainly described.

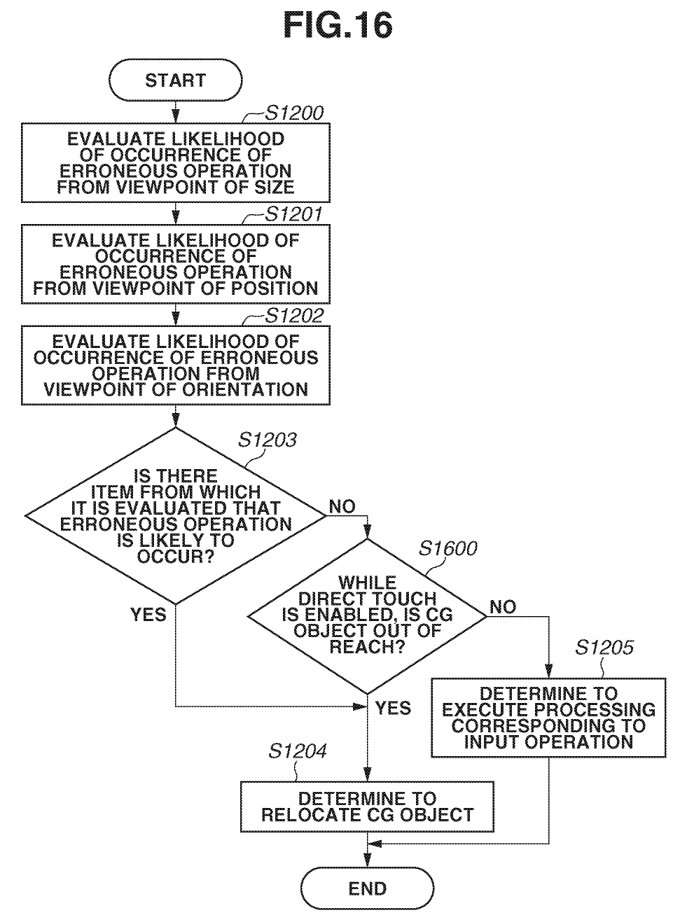

In the following description, a method for determining whether to relocate a CG object or to execute processing corresponding to an input operation in the fourth embodiment is described with reference to FIG. 16.

FIG. 16 is a flowchart illustrating the details of processing which the information processing apparatus A100 executes to determine whether to relocate a CG object in the fourth embodiment. Processing operations in the flowchart of FIG. 16 are equivalent to the processing operation in step S1104 illustrated in FIG. 11.

Processing operations in step S1200 to step S1202, step S1204, and step S1205 are similar to those described above with reference to FIG. 12 and are, therefore, omitted from description here.

In step S1203, the control unit A101 acquires, via the memory A103, the values of the likelihood of an occurrence of an erroneous operation evaluated in the respective processing operations in step S1200 to step S1202, and, based on the acquired values, determines whether to relocate the CG object. If it is determined that the CG object is evaluated to be in a state in which an erroneous operation is likely to occur from any one of the viewpoints (YES in step S1203), the control unit A101 advances the processing to step S1204 for the purpose of relocating the CG object. If it is determined that the CG object is not evaluated to be in a state in which an erroneous operation is likely to occur from any one of the viewpoints (NO in step S1203), the control unit A101 advances the processing to step S1600.

In step S1600, the control unit A101 checks whether an input operation using Direct Touch is enabled and the CG object is out of reach of the user. To check whether an input operation using Direct Touch is enabled, the control unit A101 only needs to refer to the storage unit A102 and check whether the setting for Direct Touch is currently enabled. To determine whether the CG object is out of reach of the user, the control unit A101 only needs to obtain a distance between the user and the CG object to determine whether the CG object is within the reach of the user. For example, the control unit A101 obtains a distance between the user and the CG object based on the location information about the CG object acquired in step S1102 and the posture information about the user acquired in step S1103. Furthermore, the control unit A101 can obtain, instead of the distance between the user and the CG object, a distance between an HMD worn on the user and the CG object. If it is determined that an input operation using Direct Touch is enabled and the CG object is out of reach of the user (YES in step S1600), the control unit A101 advances the processing to step S1204 for the purpose of relocating the CG object. If it is determined otherwise (NO in step S1600), the control unit A101 advances the processing to step S1205 for the purpose of executing processing corresponding to the input operation on the CG object.

As described above, when determining whether to relocate a CG object or to execute processing corresponding to an input operation, the information processing apparatus A100 in the fourth embodiment takes into consideration whether there is a possibility that the user performs an input operation using Direct Touch on the CG object.

With this configuration, in a case where a CG object is out of reach of the user, the relocation of the CG object is performed irrespective of the likelihood of an occurrence of an erroneous operation, so that it becomes possible to perform a direct operation. Therefore, since, after the relocation of the CG object, Direct Touch becomes constantly included in the options for an input operation, usability is improved.

### Fifth Embodiment

In the above-described first embodiment, second embodiment, third embodiment, and fourth embodiment, in a case where an erroneous operation is likely to occur at the time of an operation on a CG object or in a case where Direct Touch is unable to be performed, the information processing apparatus A100 performs the relocation of the CG object.

Since the reason for performing the relocation of a CG object is to prevent an erroneous operation from occurring at the time of an input operation or to expand the options for an input operation, it is not necessary to, after an input operation has ended, keep the CG object located there. Since it can be considered that the state of a CG object obtained before the relocation thereof is an ideal location obtained by the user's own selection, if an input operation on the CG object has ended, bringing the CG object back into the state obtained before the relocation thereof is considered to more contribute to an improvement in user experience.

Therefore, in a fifth embodiment, an operation which the information processing apparatus A100 performs to bring a CG object back into the location state obtained before the relocation thereof at timing when an input operation on the CG object has ended is described.

Furthermore, in the fifth embodiment, since there are many portions in common with those in the first embodiment, the second embodiment, the third embodiment, and the fourth embodiment, portions specific to the fifth embodiment are mainly described.

### Method for Determining Whether Input Operation on CG Object Has Ended

In the following description, a method for determining whether an input operation on a CG object has ended in the fifth embodiment is described.

In the fifth embodiment, in a case where an operation has not been performed for a predetermined period since an input operation has been performed on a CG object, the information processing apparatus A100 determines that the input operation on the CG object has ended.

For example, the information processing apparatus A100 sets a period such as five seconds, and, if an input operation is not performed on a CG object for five seconds or more, determines that the input operation has ended at that point of time. If an input operation has been performed within five seconds, the information processing apparatus A100 determines that the input operation has ended at timing when five seconds has elapsed after the input operation has been performed last time.

The above-mentioned method for determining whether an input operation on a CG object has ended is merely an example, and can be another method as long as it is capable of determining whether an input operation on a CG object has ended. For example, in a case where the user is performing an operation by a gesture, the information processing apparatus A100 can determine that the input operation has ended at a point of time when a predetermined period has elapsed in a state in which the user has lowered the hand. Moreover, in a case where the user is performing an operation by a gesture, the information processing apparatus A100 can determine that the input operation has ended at a point of time when a predetermined period has elapsed since the user's hand has moved outside the range of a captured image. Moreover, the timing at which to start counting of the predetermined period can be timing at which the gesture operation has been received, can be timing at which the ending of the gesture operation has been detected, or can be timing at which processing corresponding to the gesture operation has ended.

### Method for Determining whether to Bring CG Object Back into Location State Obtained Before Relocation thereof and Timing at which to Bring CG Object Back into Location State Obtained Before Relocation thereof

In the following description, a method for determining whether to bring a CG object back into a location state obtained before the relocation thereof and timing at which to bring a CG object back into a location state obtained before the relocation thereof in the fifth embodiment are described.

In the fifth embodiment, the information processing apparatus A100 determines whether to bring a CG object back into a location state obtained before the relocation thereof, depending on whether the location of the CG object has been changed by the user by the time when an input operation ends after the CG object has been relocated.

In a case where the location of the CG object has been changed by the user by the time when an input operation ends after the CG object has been relocated, the information processing apparatus A100 determines not to bring the CG object back into a location state obtained before the relocation thereof. Thus, the information processing apparatus A100 determines to maintain the position of the CG object obtained by the relocation thereof.

In a case where the location of the CG object has not been changed by the user by the time when an input operation ends after the CG object has been relocated, the information processing apparatus A100 determines to bring the CG object back into a location state obtained before the relocation thereof. Thus, the information processing apparatus A100 determines not to maintain the position of the CG object obtained by the relocation thereof.

The timing at which to bring a CG object back into a location state obtained before the relocation thereof is timing at which an input operation on the CG object has ended. In this way, bringing a CG object back into a location state obtained before the relocation thereof at timing when an input operation on the CG object has ended enables reducing the possibility that the input operation is an erroneous operation and, moreover, preventing the CG object from being located at a position which does not match the user's intention.

Furthermore, the above-mentioned method for determining whether to bring a CG object back into a location state obtained before the relocation thereof and the above-mentioned timing at which to bring a CG object back into a location state obtained before the relocation thereof are merely examples, and can be a different method and different timing.

### Flow for Determining Whether to Bring CG Object Back into Location State Obtained Before Relocation thereof

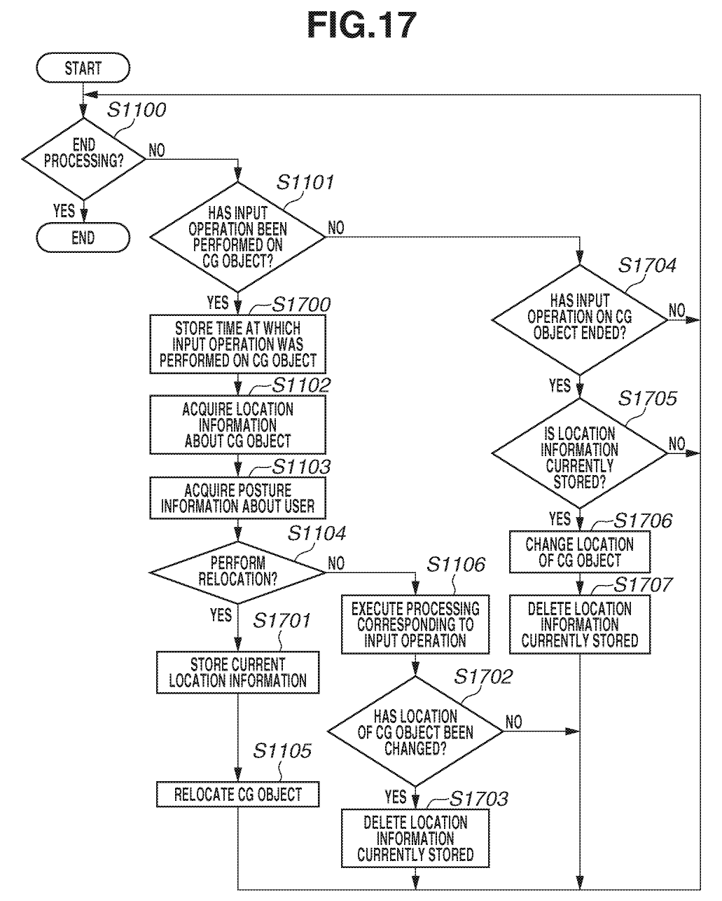

In the following description, the details of an operation of the information processing apparatus A100 in the fifth embodiment are described with reference to FIG. 17.

FIG. 17 is a flowchart for the information processing apparatus A100 in the fifth embodiment. Processing in the flowchart of FIG. 17 is started in response to a starting operation for a system or application which performs display control of a CG object being performed. Furthermore, processing operations in step S1100 to step S1102, step S1103, and step S1105 are similar to those described above with reference to FIG. 11 and are, therefore, omitted from description here.

In step S1101, the control unit A101 determines whether an input operation has been performed on any CG object via the input unit A104. If it is determined that an input operation has been performed on a CG object (YES in step S1101), the control unit A101 advances the processing to step S1700. Moreover, if it is not determined that an input operation has been performed on a CG object (NO in step S1101), the control unit A101 advances the processing to step S1704.

In step S1700, the control unit A101 stores time at which the input operation was performed on the CG object in the memory A103, and then advances the processing to step S1102.

In step S1104, the control unit A101 evaluates the likelihood of an occurrence of an erroneous operation on the CG object on which an input operation has been performed in step S1101 and determines whether to relocate the CG object or to execute processing corresponding to the input operation. The method for determining whether to relocate the CG object or to execute processing corresponding to the input operation is as described above. The control unit A101 evaluates the likelihood of an occurrence of an erroneous operation with use of the values of the location information about the CG object acquired in step S1102 and the posture information about the user acquired in step S1103, and uses a result of the evaluation to determine whether to relocate the CG object. If it is determined to relocate the CG object (YES in step S1104), the control unit A101 advances the processing to step S1701. Moreover, if it is determined to execute processing corresponding to the input operation (NO in step S1104), the control unit A101 advances the processing to step S1106.

In step S1701, before performing the relocation of the CG object in step S1105, the control unit A101 stores the current location information about the CG object obtained before the relocation thereof in the memory A103, and then advances the processing to step S1105.

In step S1702, the control unit A101 determines whether the location of the CG object has been changed by processing corresponding to the input operation in step S1106. If it is determined that the location of the CG object has been changed (YES in step S1702), the control unit A101 advances the processing to step S1703. If it is not determined that the location of the CG object has been changed (NO in step S1702), the control unit A101 returns the processing to step S1100.

In step S1703, the control unit A101 deletes the location information about the CG object obtained before the relocation thereof previously stored in the memory A103 in step S1701, and then returns the processing to step S1100. The control unit A101 refers to the memory A103 and, in a case where the location information about the CG object has already been deleted or is not previously stored, without doing anything, returns the processing to step S1100.

In step S1704, the control unit A101 acquires the last time at which an input operation was performed on the CG object, stored in the memory A103 in step S1700, and determines whether an input operation on the CG object has ended. The method for determining whether an input operation on the CG object has ended is as described above, and, if it is determined that an input operation on the CG object has ended (YES in step S1704), the control unit A101 advances the processing to step S1705. If it is not determined that an input operation on the CG object has ended (NO in step S1704), the control unit A101 returns the processing to step S1100.

In step S1705, the control unit A101 determines whether the location information about the CG object obtained before the relocation thereof, previously stored in the memory A103 in step S1701, is currently retained. If it is determined that the location information about the CG object is currently retained (YES in step S1705), the control unit A101 advances the processing to step S1706. If it is determined that the location information about the CG object is not currently retained or the location information about the CG object is already deleted (NO in step S1705), the control unit A101 returns the processing to step S1100.

In step S1706, the control unit A101 acquires the location information about the CG object obtained before the relocation thereof, previously stored in the memory A103 in step S1701, changes the location of the CG object, and then advances the processing to step S1707.

In step S1707, the control unit A101 deletes the location information about the CG object obtained before the relocation thereof, previously stored in the memory A103 in step S1701, and then returns the processing to step S1100. The control unit A101 refers to the memory A103 and, in a case where the location information about the CG object has already been deleted or is not previously stored, without doing anything, returns the processing to step S1100.

As described above, the information processing apparatus A100 in the fifth embodiment performs processing for bringing a CG object back into a location state obtained before the relocation of the CG object, at timing when an input operation on the CG object has ended.

With this configuration, when an input operation is performed on a CG object, the CG object comes into a state in which an erroneous operation is unlikely to occur or a state in which the range of options for an input operation is wide, and, after the input operation on the CG object has ended, the CG object returns to an ideal location which the user has performed, so that the user experience is improved.

### Sixth Embodiment

In the above-described first embodiment, second embodiment, third embodiment, fourth embodiment, and fifth embodiment, descriptions have been made on the premise that the user who is watching a CG object is only one user wearing an HMD.

However, depending on HMD systems, there is a case where a share function which allows a plurality of persons to watch a CG object at the same time is provided.

In a case where such a share function is being used, when someone has performed an input operation on a CG object, if the CG object is relocated, with regard to the user who has performed the input operation, the CG object comes into a state in which an erroneous operation is unlikely to occur or a state in which the range of options for an input operation is wide. However, with regard to a user who has not performed the input operation, the CG object is relocated without permission and thus comes into a state of being difficult to watch, so that the user experience may deteriorate.

Therefore, in a sixth embodiment, in a case where a CG object is being watched by a plurality of persons at the same time, with respect to a user who performs an input operation, the information processing apparatus A100 displays a CG object which has been relocated as needed, and, with respect to the other users, the information processing apparatus A100 displays the CG object the location of which is unchanged. Such an operation of the information processing apparatus A100 is described as follows.

Furthermore, in the sixth embodiment, since there are many portions in common with those in the first embodiment, the second embodiment, the third embodiment, the fourth embodiment, and the fifth embodiment, portions specific to the sixth embodiment are mainly described.

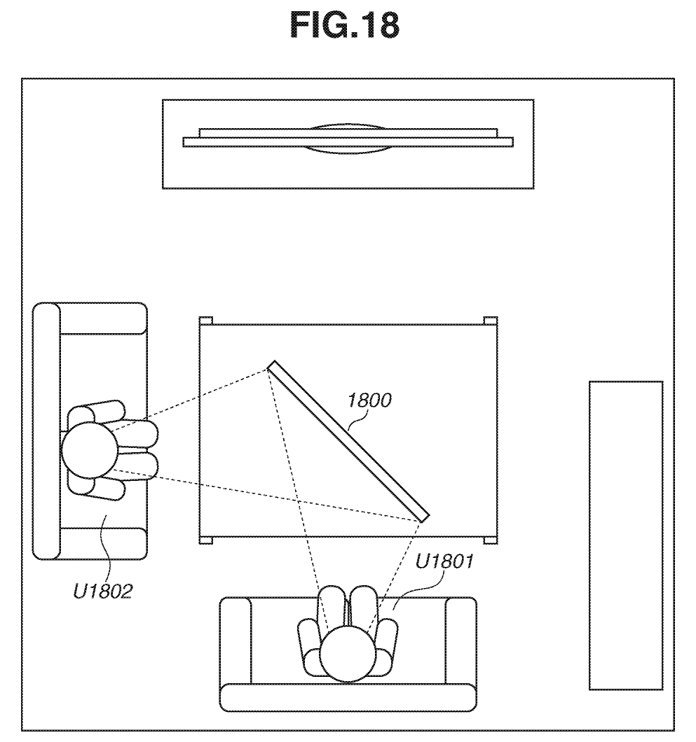

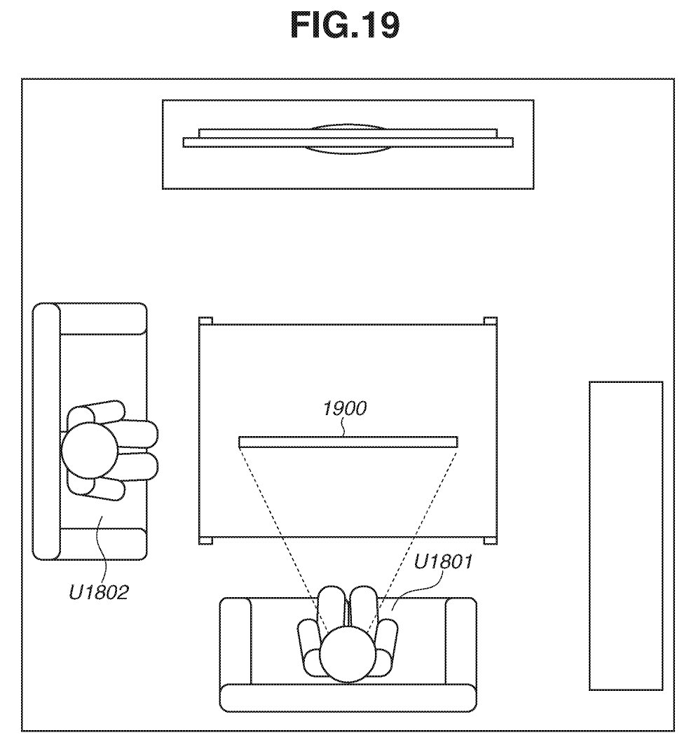

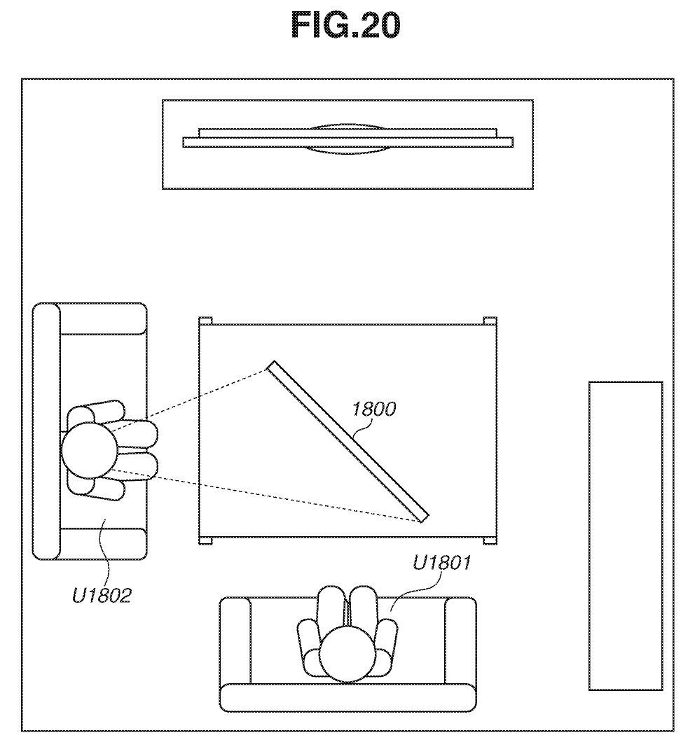

In the following description, how a CG object looks to each user is described with reference to FIG. 18, FIG. 19, and FIG. 20.

FIG. 18 is a diagram representing a scene in which two users (U1801 and U1802) each wearing an HMD are concurrently watching a shared CG object 1800. At this time, two users U1801 and U1802 are able to visually recognize the CG object 1800 although each from an angle.

In the description here, a scene in which the user U1801 performs an input operation on the CG object 1800 and the user U1802 performs only watching of the CG object 1800 is supposed.

FIG. 19 is a diagram representing a scene in which the user U1801 has performed an input operation and, in response to the input operation, the CG object 1800 has been relocated. A CG object 1900 is obtained by the CG object 1800 being relocated.

FIG. 20 is a diagram used to explain a scene in which, in a case where the information processing apparatus A100 has performed the relocation of the CG object with respect to the user U1801, the information processing apparatus A100 displays the CG object 1800 with respect to the user U1802, who is not operating the CG object.

As illustrated in FIG. 19, the information processing apparatus A100 displays the relocated CG object 1900 with respect to the user U1801, who has performed an input operation on the CG object. Here, if the information processing apparatus A100 also displays the relocated CG object 1900 with respect to the user U1802, since the user U1802 is just to the lateral side of the CG object 1900, the visibility of the CG object 1900 deteriorates. Therefore, in the case of a scene such as that illustrated in FIG. 19, the information processing apparatus A100 locates the CG object as illustrated in FIG. 20 described below, thus preventing a deterioration of the visibility of the CG object with respect to the user U1802. Moreover, a configuration in which, when the user U1801 has ended an input operation, the CG object returns to the state illustrated in FIG. 18, so that the CG object 1800 with the same location is displayed again with respect to the user U1801 and the user U1802, can be employed.

How the CG object looks to each user as described above is merely an example, and respective conditions such as the number of users, the location of each user, and the location of a CG object can be different ones.

### Method for Determining, At the Time of Ending of Input Operation, Whether to Bring CG Object Back into Location State Obtained Before Relocation or to Change CG Object to Different Location State

In the following description, a method for determining, at the time of ending of an input operation, whether to bring a CG object back into a location state obtained before the relocation thereof or to change the CG object to a different location state in the sixth embodiment is described.

In the above-described fifth embodiment, since there is only one user, it is supposed that, in a case where a CG object has been relocated by an input operation, unless the location of the CG object is further changed by the user, the information processing apparatus A100 brings the CG object back into a location state obtained before the relocation thereof at timing when the input operation has ended.

However, in a case where a plurality of persons is watching a CG object as in the sixth embodiment, a plurality of users may concurrently perform an input operation on the CG object.

Therefore, in the sixth embodiment, in a case where, during an input operation being performed, the location of the CG object has been changed by a second user, the information processing apparatus A100, instead of bringing the CG object back into a location state obtained before the relocation thereof at the time of ending of the input operation, changes the location of the CG object to a location determined by the second user.

The above-mentioned method for determining, at the time of ending of an input operation, whether to bring a CG object back into a location state obtained before the relocation thereof or to change the CG object to a different location state is merely an example, and can be a different method.

### Specific Example of Operation at the Time of Ending of Input Operation

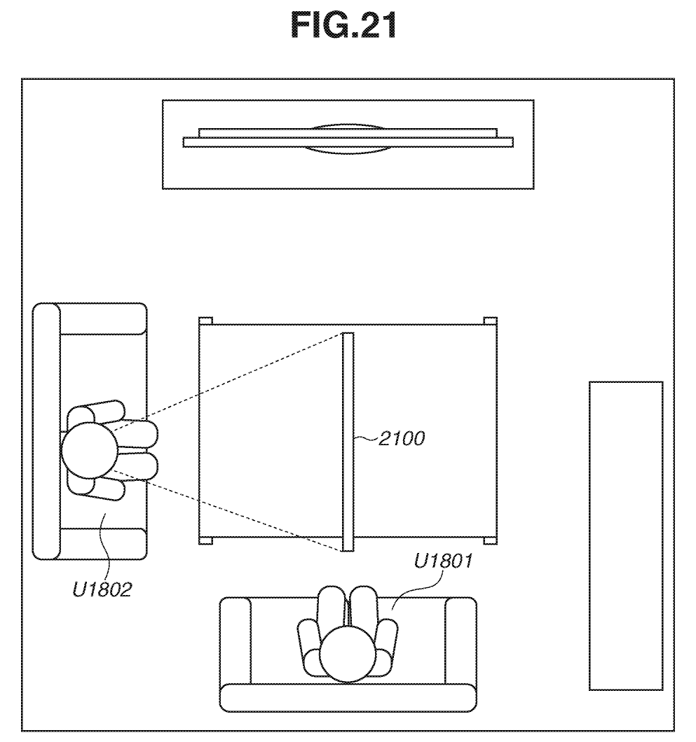

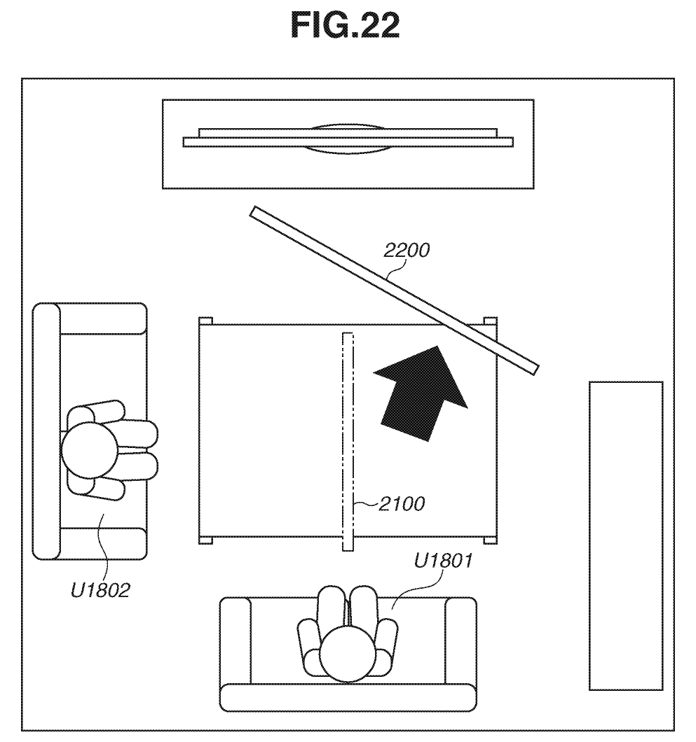

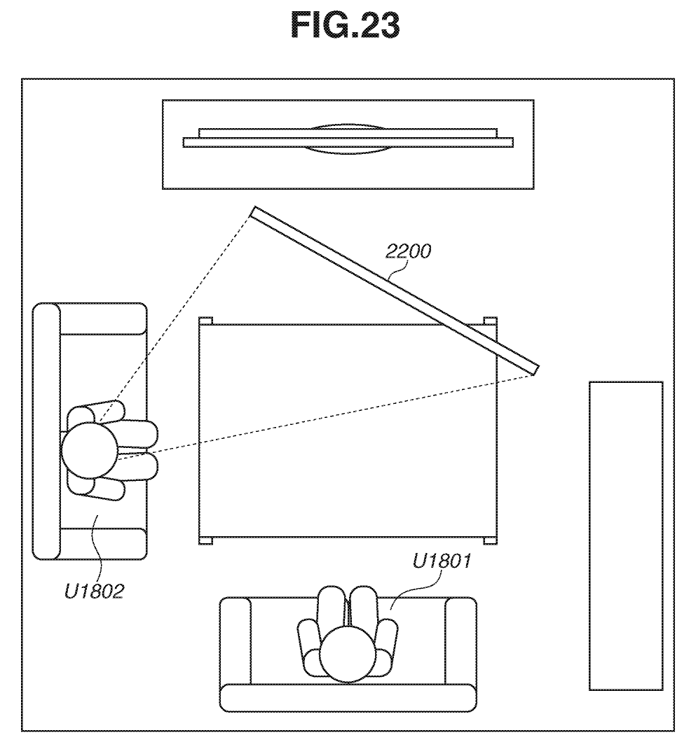

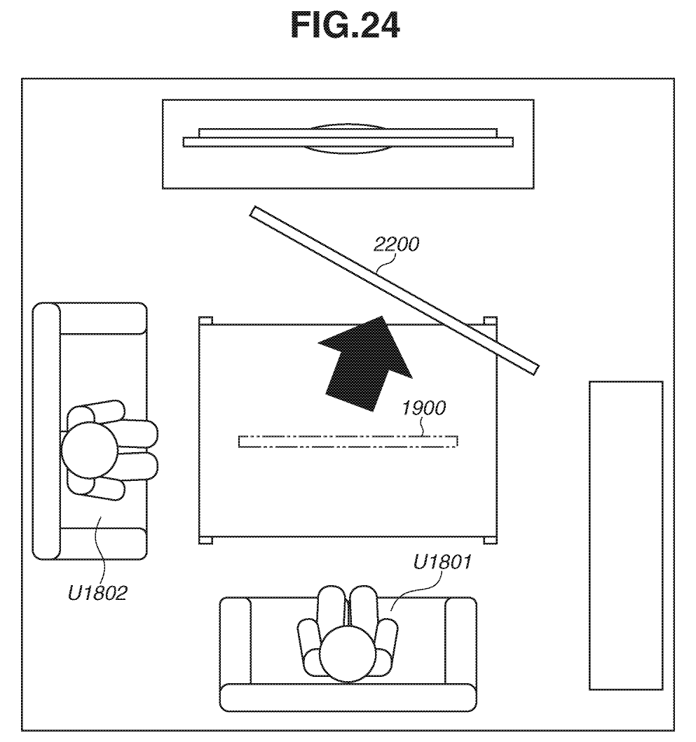

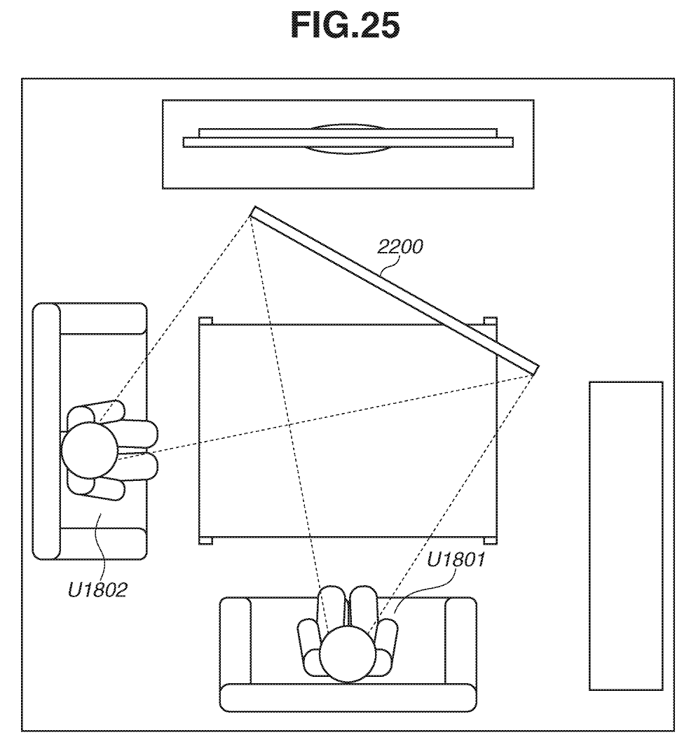

In the following description, an operation which the information processing apparatus A100 performs at the time of ending of an input operation in the sixth embodiment is described with specific examples with reference to FIG. 18, FIG. 19, FIG. 20, FIG. 21, FIG. 22, FIG. 23, FIG. 24, and FIG. 25.

FIG. 18 is a diagram assuming a scene in which the user U1801 and the user U1802 are watching the same CG object 1800. Moreover, FIG. 19 is a diagram assuming a scene in which the user U1801 has performed an input operation and, in response to the input operation, the CG object has been relocated. Moreover, FIG. 20 is a diagram assuming a scene in which, at timing when the user U1801 has performed an input operation and, in response to the input operation, the CG object has been relocated, the information processing apparatus A100 displays the CG object 1800 with respect to the user U1802, who is not operating the CG object.

Moreover, FIG. 21 is a diagram assuming a scene in which, when an operation for changing the location of the CG object is performed by the user U1802, a relocated CG object 2100 is displayed. Moreover, FIG. 22 is a diagram assuming a scene in which an operation for changing the location of the CG object 2100 to the location of a CG object 2200 is performed by the user U1802. Moreover, FIG. 23 is a diagram assuming a scene in which the CG object 2200, the location of which has been changed by an operation performed by the user U1802 in the scene illustrated in FIG. 22, is displayed.

Moreover, FIG. 24 is a diagram assuming a scene in which, after an input operation performed by the user U1801 has been completed, the location of the CG object 1900 is changed to the location of the CG object 2200.

Moreover, FIG. 25 is a diagram assuming a scene in which the user U1801 and the user U1802 are watching the same CG object 2200 which has been relocated.

In the following description, the flow of processing from the scene illustrated in FIG. 18 to the scene illustrated in FIG. 25 is described. First, starting with the state (FIG. 18) in which the user U1801 and the user U1802 are watching the same CG object 1800, an input operation is performed by the user U1801. At this time, with respect to the user U1801, the CG object 1900, which has been relocated, is displayed (FIG. 19), and, with respect to the user U1802, the CG object 1800, which is not relocated, is kept displayed (FIG. 20). Next, when an operation for changing the location of the CG object 1800 is performed by the user U1802, the CG object 1800 is relocated to the position of the CG object 2100 (FIG. 21). After that, when an operation for locating the CG object 2100 to the position of the CG object 2200 is performed by the user U1802 (FIG. 22), a screen located at the position of the CG object 2200 is displayed with respect to the user U1802 (FIG. 23). Furthermore, at this time, a scene in which the user U1801 has not yet completed an input operation is assumed, and, with respect to the user U1801, the CG object 1900, which has been relocated, is kept displayed (FIG. 19). Finally, when an input operation performed by the user U1801 has been completed, with respect to the user U1801, the CG object 1900 is relocated to the position of the CG object 2200 (FIG. 24). With this flow, finally, a scene in which the user U1801 and the user U1802 are watching the same CG object 2200, which has been relocated, appears (FIG. 25).

In this way, in a case where, during an input operation being performed on the CG object by a user, a second user has changed the location of the CG object, the information processing apparatus A100, instead of bringing the CG object back into a location state obtained before the relocation thereof at the time of ending of the input operation, changes the location of the CG object to a new location state of the CG object located by the second user.

The above-mentioned operation at the time of ending of an input operation is merely an example, and can be a different operation.

Furthermore, the information processing apparatus A100 can be configured to issue a notification indicating that a second user is operating a CG object, a CG object is in a state of being relocated with respect to a screen for a second user, or the location of a CG object is different with respect to a screen for a second user. Alternatively, the information processing apparatus A100 can be configured to issue a notification indicating that the relocation of a CG object is performed in response to an operation performed by a second user or issue a notification of the position to which a CG object is relocated. With this configuration, the user is able to preliminarily know whether an operation is currently being performed by a second user or whether, after this, the relocation of a CG object will be performed in response to, for example, an operation performed by a second user.

### Flow of Relocation When Plurality of Users is Watching Shared CG Object

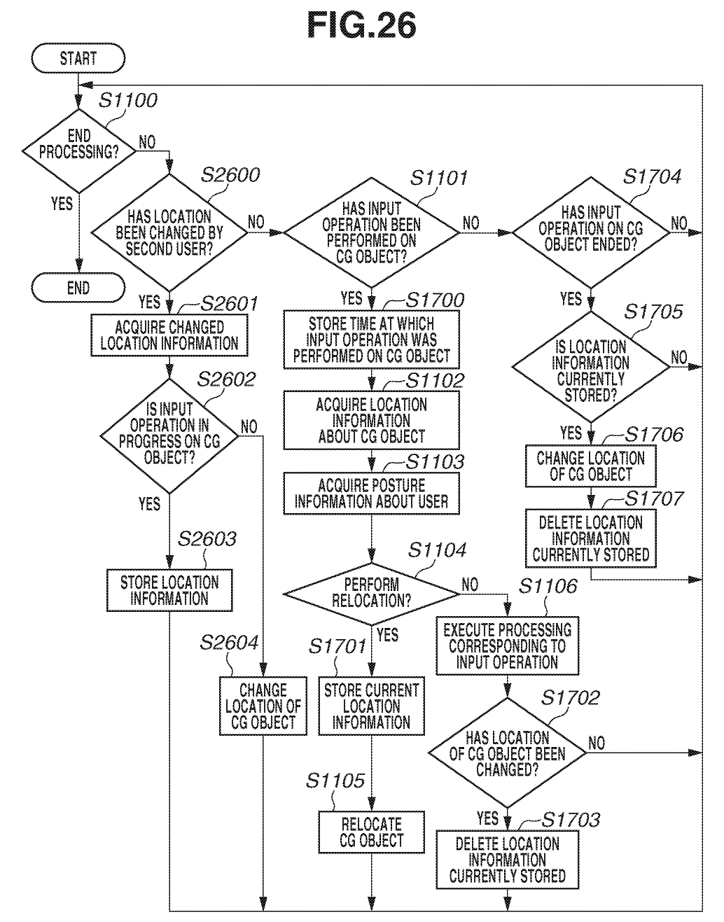

In the following description, the details of an operation which the information processing apparatus A100 performs in the sixth embodiment are described with reference to FIG. 26.

FIG. 26 is a flowchart for the information processing apparatus A100 in the sixth embodiment. Processing in the flowchart of FIG. 26 is started in response to a starting operation for a system or application which performs displaying of a CG object to a plurality of users being performed.

Processing operations in step S1101 to step S1106, and step S1700 to step S1707 are similar to those described above with reference to FIG. 17 and are, therefore, omitted from description here.

In step S1100, the control unit A101 determines whether to end processing, based on the state of each unit of the information processing apparatus A100. For example, in a case where an ending operation has been performed via the input unit A104 (YES in step S1100), the control unit A101 ends the processing in the present flowchart. If it is determined to continue the processing (NO in step S1100), the control unit A101 advances the processing to step S2600.

In step S2600, the control unit A101 determines, via the communication unit A107, whether the location of a CG object has been changed by a second user. If it is determined that the location of a CG object has been changed by a second user (YES in step S2600), the control unit A101 advances the processing to step S2601. If it is determined that the location of a CG object has not been changed by a second user (NO in step S2600), the control unit A101 advances the processing to step S1101.

In step S2601, the control unit A101 acquires, via the communication unit A107, new location information about the CG object the location of which has been changed by the second user.

In step S2602, the control unit A101 acquires the last time at which an input operation was performed on the CG object, stored in the memory A103 in step S1700, and determines whether the input operation is in progress on the CG object. If it is determined that the input operation is in progress on the CG object (YES in step S2602), the control unit A101 advances the processing to step S2603. If it is determined that the input operation is not in progress on the CG object (NO in step S2602), the control unit A101 advances the processing to step S2604.

In step S2603, the control unit A101 stores, in the memory A103, the new location information about the CG object acquired in step S2601. At this time, the control unit A101 stores data at the same position as the position in which to store the location information in step S1701, and, in a case where the location information has already been stored in step S1701 or step S2603, overwrites the data.

In step S2604, the control unit A101 changes the location of the CG object with use of the new location information about the CG object acquired in step S2601.

The processing operation in step S1706 is the same as the operation described above in the fifth embodiment. However, in a case where the location information about the CG object stored in the memory A103 in step S1701 has been previously overwritten in step S2603, the CG object, instead of returning to a state obtained before the relocation thereof, is changed to a new state which has been changed by the second user.

As described above, in a case where a CG object is being watched concurrently by a plurality of persons, the information processing apparatus A100 in the sixth embodiment displays a CG object which has been relocated as needed with respect to a user who is performing an input operation. Moreover, the information processing apparatus A100 displays a CG object which has been kept unchanged with respect to a user who is not performing an input operation.

With this configuration, in a case where a CG object is being watched concurrently by a plurality of persons, even if someone performs an input operation on the CG object, the CG object does not become difficult to watch even with respect to the other user, so that it is possible to prevent the user experience from deteriorating.

### Seventh Embodiment

In the above-described first embodiment, second embodiment, third embodiment, fourth embodiment, fifth embodiment, and sixth embodiment, the relocation of a CG object is performed as needed at the time of an input operation on the CG object. In a case where an input operation has been performed on a CG object, whether to relocate the CG object or to execute processing corresponding to the input operation is as described above in each embodiment. Here, there is a case where, without trying to perform an input operation on a CG object, it is difficult for the user to determine whether the CG object will be relocated or processing corresponding to the input operation will be executed. If, when performing an input operation, the user does not know which processing will be executed, in a case where an operation which is performed is different from the user's understanding, the user experience may become worse.

Therefore, in a seventh embodiment, when the user attempts to perform an input operation on a CG object, the information processing apparatus A100 switches a displaying method for the CG object and thus informs the user whether to perform the relocation of the CG object or to execute processing corresponding to the input operation. Such an operation of the information processing apparatus A100 is described as follows.

Furthermore, in the seventh embodiment, since there are many portions in common with those in the first embodiment, the second embodiment, the third embodiment, the fourth embodiment, the fifth embodiment, and the sixth embodiment, portions specific to the seventh embodiment are mainly described.

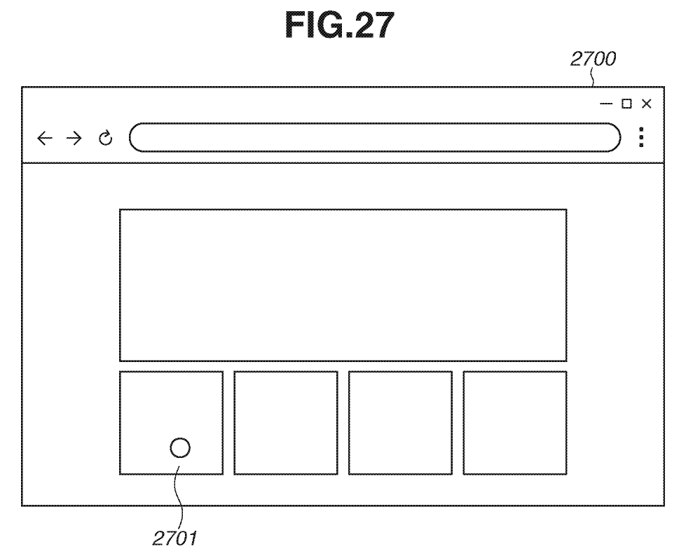

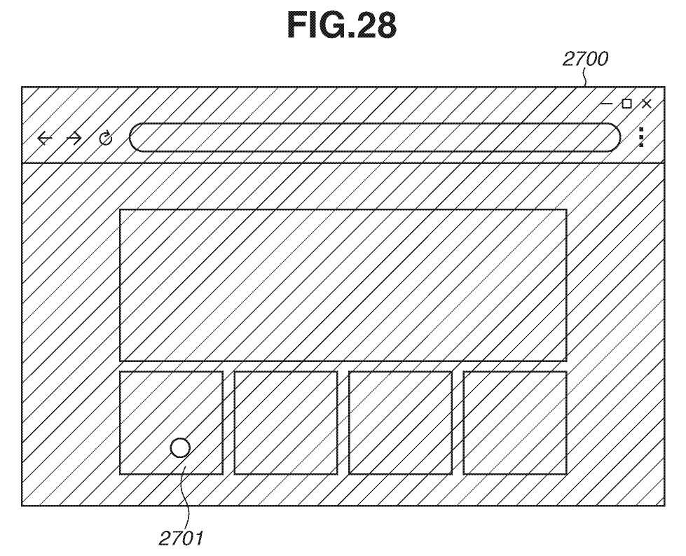

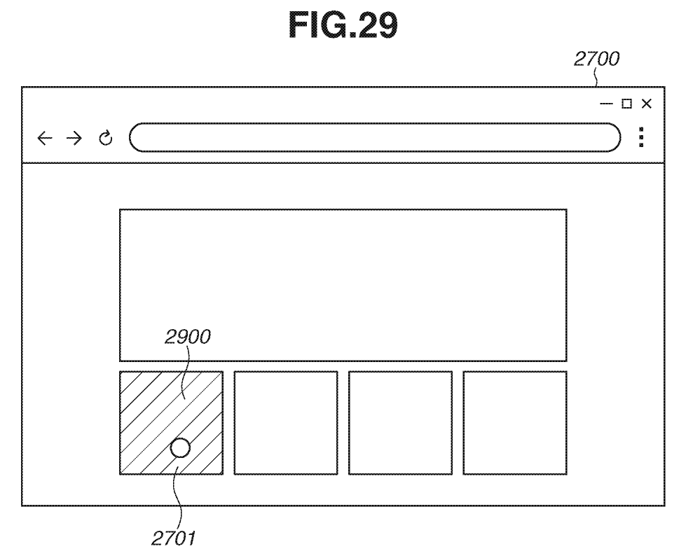

In the following description, an effect which is displayed in a CG object in the seventh embodiment is described with reference to FIG. 27, FIG. 28, and FIG. 29.

FIG. 27 is a diagram illustrating a CG object 2700 equipped with UI parts serving as a browser. The CG object 2700 is configured with a plurality of UI parts serving as a browser, and a pointer 2701 is an indicator for indicating where the user is pointing in the browser. The pointer 2701 is displayed at the position to which the line of sight is directed in the case of an operation using the line of sight input, at the position to which the hand or a controller is directed in the case of a ray operation, or at the position which the finger is going to touch in the case of Direct Touch.

In the seventh embodiment, when the user attempts to perform an input operation on a CG object, the information processing apparatus A100 switches an effect which is displayed in the CG object depending on whether to relocate the CG object or to execute processing corresponding to the input operation.

When, in response to an input operation being performed on a CG object, relocating the CG object, the information processing apparatus A100 applies an effect to the entire CG object 2700 as illustrated in FIG. 28. In the case illustrated in FIG. 28, an effect is applied to the entire CG object, thus being able to inform the user that, in response to the user performing an input operation (tap operation) in such a state, the CG object is relocated. Thus, in a case where an effect has been applied to the entire CG object 2700 as illustrated in FIG. 28, instead of an original input operation, an operation for the relocation of the CG object is performed.

When, in response to an input operation being performed on a CG object, executing processing corresponding to the input operation, the information processing apparatus A100 applies an effect to a part of the UI on the CG object as illustrated in FIG. 29. In the case illustrated in FIG. 29, an effect is applied to a button 2900 to which the pointer 2701 points, thus being able to inform the user that, in response to the user performing an input operation (tap operation) in such a state, the button 2900 is pressed. Thus, in a case where an effect has been applied to a part of the UI on the CG object as illustrated in FIG. 29, an original input operation is performed.

The above-described effect which is displayed in a CG object is merely an example, and the method for informing the user of an operation which is to be executed by the information processing apparatus A100 in response to an input operation can be a different method.

As described above, when the user attempts to perform an input operation on a CG object, the information processing apparatus A100 in the seventh embodiment switches an effect which is displayed in the CG object depending on whether to relocate the CG object or to execute processing corresponding to the input operation.

With this configuration, when performing an input operation, the user comes to understand which of processing for an original input operation and processing for the relocation of a CG object will be performed, and, since the same operation as the user's recognition is performed, it is possible to prevent the user experience from deteriorating.

While some embodiments of the present disclosure have been described, the present disclosure is not limited to these embodiments, and can be modified or altered in various manners within the range of the gist thereof.

According to an aspect of the present disclosure, even with regard to an operation in a three-dimensional space, it is possible to improve user operability.

### Other Embodiments

Embodiment(s) of the present disclosure can also be realized by a computer of a system or apparatus that reads out and executes computer-executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has described example embodiments, it is to be understood that some embodiments are not limited to the disclosed embodiments. The scope of the following claims is to be accorded the broadest interpretation so as to encompass all such modifications and equivalent structures and functions.

This application claims priority to Japanese Patent Application No. 2025-030296, which was filed on February 27, 2025 and which is hereby incorporated by reference herein in its entirety.

What is claimed is:

1. An information processing apparatus adapted to be connected to or integrated into a display device, the information processing apparatus comprising:
a processor; and
a memory storing instructions that, when executed by the processor, cause the information processing apparatus to:
execute acquisition processing for acquiring an operation performed on a virtual object located in a space;
in a case where a first operation different from an operation for changing a location of the virtual object has been acquired by the acquisition processing, perform control to execute, on the virtual object, first processing corresponding to the first operation and different from processing for changing a location of the virtual object; and
in a case where a predetermined condition is satisfied, even if the first operation is acquired by the acquisition processing, perform control to execute second processing different from the first processing and related to a relocation of the virtual object in the space.

2. The information processing apparatus according to claim 1, wherein, in a case where the virtual object is in a situation in which an erroneous operation is likely to occur, the predetermined condition is satisfied.

3. The information processing apparatus according to claim 1,
wherein the instructions further cause the information processing apparatus to execute determination processing for determining whether the virtual object is in a situation in which an erroneous operation is likely to occur, and
wherein, if it is determined by the determination processing that the virtual object is in a situation in which an erroneous operation is likely to occur, the predetermined condition is satisfied.

4. The information processing apparatus according to claim 1, wherein the predetermined condition is a predetermined condition related to at least one of a size, position, and orientation of the virtual object.

5. The information processing apparatus according to claim 1,
wherein the virtual object is a virtual window, and
wherein, in a case where the virtual window is not facing a front of the display device, the predetermined condition is satisfied.

6. The information processing apparatus according to claim 1, wherein, in a case where an object operable by a user and included in the virtual object is smaller in size than a threshold value, the predetermined condition is satisfied.

7. The information processing apparatus according to claim 1, wherein, in a case where at least a part of the virtual object on which the first operation is performed is hidden by another virtual object, the predetermined condition is satisfied.

8. The information processing apparatus according to claim 1, wherein, in a case where the predetermined condition is satisfied, the instructions further cause the information processing apparatus to perform control to, as the second processing, change at least one of a size, position, and orientation of the virtual object.

9. The information processing apparatus according to claim 1, wherein, in a case where at least one element of elements including a size, position, and orientation of the virtual object is previously fixed, the instructions further cause the information processing apparatus to perform control not to perform relocation with respect to the fixed element of the elements including the size, position, and orientation of the virtual object.

10. The information processing apparatus according to claim 1, wherein the instructions further cause the information processing apparatus to perform control to execute the second processing in such a manner that the virtual object assumes a predetermined size.

11. The information processing apparatus according to claim 1,
wherein the predetermined condition is a condition related to a distance from a user to the virtual object, and
wherein, in a case where the predetermined condition is satisfied, the instructions further cause the information processing apparatus to perform control to execute the second processing in such a way as to relocate the virtual object at a distance available for the user to directly operate the virtual object.

12. The information processing apparatus according to claim 1,
wherein the instructions further cause the information processing apparatus to execute display control processing for displaying the virtual object on the display device, and
wherein the display control processing makes displaying the virtual object different between a case where the predetermined condition is satisfied and a case where the predetermined condition is not satisfied.

13. The information processing apparatus according to claim 1, wherein, in a case where the predetermined condition is satisfied, the instructions further cause the information processing apparatus to execute notification processing for issuing a notification indicating that, even if the first operation is performed, the first processing is not executed.

14. The information processing apparatus according to claim 1, wherein, in a case where, after the first processing has been executed in a state in which the second processing has been executed on the virtual object, no operation has been acquired by the acquisition processing for a predetermined time, the instructions further cause the information processing apparatus to perform control to bring the virtual object with the second processing executed thereon back into a state of the virtual object obtained before the second processing is executed thereon.

15. The information processing apparatus according to claim 1, wherein, in a case where the virtual object is watched concurrently by a plurality of users including a first user and a second user, the instructions further cause the information processing apparatus to perform control in such a manner that, even if, in response to the second processing related to a relocation of the virtual object in the space being executed by the first operation performed by the first user, the relocation of the virtual object which is displayed with respect to the first user has been performed, the relocation of the virtual object which is displayed with respect to the second user, who is not performing the first operation, is not performed.

16. The information processing apparatus according to claim 1, wherein, in a case where the virtual object is watched concurrently by a plurality of users including a first user and a second user, the instructions further cause the information processing apparatus to perform control in such a manner that, in a case where, during a period when, in response to the second processing being executed by the first operation performed by the first user, the relocation of the virtual object which is displayed with respect to the first user is being performed, a state of the virtual object is previously changed by the second user, after the first processing corresponding to the first operation performed by the first user is executed, the virtual object which is displayed with respect to the first user is changed to the state of the virtual object changed by the second user.

17. An information processing method comprising:
acquiring an operation performed on a virtual object located in a space;
in a case where a first operation different from an operation for changing a location of the virtual object has been acquired, performing control to execute, on the virtual object, first processing corresponding to the first operation and different from processing for changing a location of the virtual object; and
in a case where a predetermined condition is satisfied, even if the first operation is acquired, performing control to execute second processing different from the first processing and related to a relocation of the virtual object in the space.

18. A non-transitory computer-readable storage medium storing instructions that, when executed by a computer, cause an information processing apparatus adapted to be connected to or integrated into a display device to perform a method comprising:
acquiring an operation performed on a virtual object located in a space;
in a case where a first operation different from an operation for changing a location of the virtual object has been acquired, performing control to execute, on the virtual object, first processing corresponding to the first operation and different from processing for changing a location of the virtual object; and
in a case where a predetermined condition is satisfied, even if the first operation is acquired, performing control to execute second processing different from the first processing and related to a relocation of the virtual object in the space.

19. An information processing system comprising:
a first device configured to acquire an operation performed on a virtual object located in a space; and
a control device configured to, in a case where a first operation different from an operation for changing a location of the virtual object has been acquired by the first device, perform control to execute, on the virtual object, first processing corresponding to the first operation and different from processing for changing a location of the virtual object,
wherein, in a case where a predetermined condition is satisfied, even if the first operation is acquired by the first device, the control device performs control to execute second processing different from the first processing and related to a relocation of the virtual object in the space.
